(19) United States
(12) Patent Application Publication
(10) Pub. No.: US 2026/0289509 A1
(43) Pub. Date: Sep. 24, 2026

(54) SYSTEM

(71) Applicant: SoftBank Group Corp., Tokyo (JP)

(72) Inventor: Kazuhiro HATAKEDA, Tokyo (JP)

(73) Assignee: SoftBank Group Corp., Tokyo (JP)

(21) Appl. No.: 19/567,312

(22) Filed: Mar. 16, 2026

(30) Foreign Application Priority Data
Mar. 19, 2025 (JP) 2025-045127

(51) Int. Cl. G06Q 10/1053

(52) U.S. Cl. CPC G06Q 10/1053

(57) ABSTRACT

A system includes a processor that is configured to generate a prompt text for causing a generative artificial intelligence model to learn a company philosophy and a unique company culture, conduct an interview by using an artificial intelligence that has learned the company philosophy and the unique company culture, analyze an answer of a candidate by using a natural language processing technique, recognize an emotion of the candidate based on an analysis result of the answer, and provide real-time feedback by using an emotion engine.

### CROSS-REFERENCE TO RELATED APPLICATION

This application is based on and claims priority under 35 USC 119 from Japanese Patent Application No. 2025-045127 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional interview systems and online recruitment tools are limited in their ability to deeply evaluate a candidate's compatibility with a company's philosophy and unique culture. In many cases, interview questions are based on fixed templates and are not explicitly grounded in actual corporate documents such as official websites or internal policies. As a result, it is difficult to objectively and consistently assess how a candidate's values and mindset align with the company's mission, vision, and working style.

Furthermore, when interviews are conducted by human interviewers, there is often a psychological barrier for both the interviewer and the candidate to ask or answer questions that are sensitive, personal, or otherwise difficult to address face-to-face. This leads to a situation where the candidate's true motivations, honest opinions, and latent concerns about the company are not sufficiently drawn out, which can cause mismatches after hiring and reduce the effectiveness of the recruitment process.

In addition, conventional systems generally lack mechanisms for real-time emotional understanding during interviews. Even when text-based or video-based interviews are recorded, the emotional state of a candidate (such as anxiety, enthusiasm, confusion, or hesitation) is rarely analyzed in real time, and is therefore not reflected in the interview flow. Consequently, questions are not adaptively adjusted according to the candidate's emotions, and timely feedback or support tailored to the candidate's state is not provided.

There is thus a need for a system that: (i) uses a generative artificial intelligence model to learn and internalize a company's philosophy and unique culture directly from corporate information sources; (ii) conducts interviews using the learned artificial intelligence so as to ask questions closely tied to the company's values; (iii) analyzes candidates' answers using natural language processing to recognize their emotions; and (iv) utilizes an emotion engine to provide real-time feedback and dynamically adjust the interview content and order in accordance with the candidate's emotional state, including questions that are difficult to ask in person and exchanges aimed at eliciting honest opinions.

### SUMMARY

In order to solve the foregoing problems, according to one aspect of the present invention, there is provided a system comprising a processor, wherein the processor is configured to generate a prompt text for causing a generative artificial intelligence model to learn a company philosophy and a unique company culture, conduct an interview by using an artificial intelligence that has learned the company philosophy and the unique company culture, analyze an answer of a candidate by using a natural language processing technique, recognize an emotion of the candidate based on an analysis result of the answer, and provide real-time feedback by using an emotion engine.

More specifically, the processor generates, based on corporate information such as an official company website, internal documents, and culture guidelines, a prompt text that instructs the generative artificial intelligence model to extract and internalize elements of the company's philosophy and unique culture. By executing learning using this prompt text, the generative artificial intelligence model becomes specialized in the target company's mission, values, and work practices, and is then used as an interviewer in a virtual interview environment.

In the interview, the processor controls the learned artificial intelligence to output interview questions that are explicitly grounded in the learned company philosophy and unique culture, and receives from a candidate natural-language answers to the questions. The processor then applies natural language processing techniques to the candidate's answers to extract semantic features, sentiment indicators, and other linguistic characteristics, and recognizes an emotion of the candidate (for example, interest, anxiety, agreement, skepticism, or hesitation) based on an analysis result of the answer. The processor further cooperates with the emotion engine to provide real-time feedback, such as encouraging messages, clarifying explanations, or follow-up questions tailored to the recognized emotional state, thereby supporting a more natural and adaptive conversational flow.

In another aspect, the processor is configured to generate a prompt text for conducting questions and exchanges that are difficult to ask in person and for eliciting honest opinions from the candidate, and to generate one or more questions based on the generated prompt text. By doing so, the system enables the artificial intelligence to autonomously create and pose sensitive or in-depth questions that human interviewers might hesitate to ask, such as questions about the candidate's true expectations, perceived risks, or doubts concerning the company. This mechanism allows the system to draw out the candidate's honest thoughts in a psychologically safe environment and to capture nuanced information that is often omitted in conventional interviews.

In a further aspect, the processor is configured to analyze an emotional state of the candidate, generate a prompt text for dynamically changing interview question content or an interview question order based on an analysis result of the emotional state, and adjust the interview based on the generated prompt text. Concretely, when the processor detects, via emotion recognition, that the candidate is confused, overly nervous, or highly engaged, the processor generates a control prompt that instructs the artificial intelligence to, for example, switch to easier or more explanatory questions, insert supportive feedback, or deepen certain topics. The interview content and sequence are thus dynamically adapted in real time in accordance with the candidate's emotional state. As a result, the system not only improves the accuracy and granularity of cultural fit assessment, but also enhances the candidate experience by providing interactive, emotionally aware interviews that reflect both the company's philosophy and the candidate's emotional responses.

The term “processor” refers to a hardware and/or software processing unit, such as a central processing unit (CPU), graphics processing unit (GPU), application-specific integrated circuit (ASIC), field-programmable gate array (FPGA), or a combination thereof, that executes instructions to perform the functions described in the present specification.

The term “generative artificial intelligence model” refers to an artificial intelligence model, such as a large language model or other generative model, that is configured to generate text, prompts, questions, or other content in response to input data or instructions.

The term “prompt text” refers to a text string or structured textual instruction supplied to a generative artificial intelligence model, the text string or structured textual instruction being configured to cause the generative artificial intelligence model to perform a specific operation, such as learning a company philosophy and a unique company culture or generating interview questions.

The term “company philosophy” refers to a set of statements, principles, mission descriptions, vision descriptions, values, and related concepts that define the fundamental purpose, beliefs, and long-term direction of a company.

The term “unique company culture” refers to a set of behavioral norms, practices, communication styles, workflows, and implicit or explicit rules that characterize how employees of a specific company work together and make decisions, the set being distinguished from those of other companies.

The term “artificial intelligence” refers to a software system or model capable of performing tasks that typically require human intelligence, including understanding natural language, generating natural language, and making decisions or inferences based on input data.

The term “interview” refers to an interactive question-and-answer session conducted between the artificial intelligence and a candidate, the interactive question-and-answer session being intended to evaluate the candidate with respect to at least one of skills, suitability, or compatibility with a company philosophy and a unique company culture.

The term “candidate” refers to a person who is subject to evaluation in an interview, including but not limited to a job applicant or an individual being assessed for a role, position, or affiliation with a company.

The term “answer of a candidate” refers to a natural-language response provided by the candidate to a question presented during the interview, the natural-language response being in text form, voice-transcribed text form, or another form that can be processed as text.

The term “natural language processing technique” refers to a computational method or algorithm configured to analyze, interpret, and process human language text, including but not limited to tokenization, parsing, sentiment analysis, semantic analysis, intent detection, or entity extraction.

The term “analysis result” refers to data generated by applying a natural language processing technique to an answer of a candidate, the data including at least one of semantic features, sentiment indicators, topic classifications, or other derived attributes.

The term “emotion” refers to an affective state of a candidate, such as interest, enthusiasm, satisfaction, anxiety, confusion, skepticism, hesitation, or other emotional conditions, that can be inferred from the candidate's answer or behavior.

The term “emotion of the candidate” refers to an emotional state that is recognized or inferred by the system based on an analysis result of at least one answer of the candidate.

The term “emotion engine” refers to a software module or combination of hardware and software configured to process an analysis result and recognize, infer, or track an emotion of a candidate, and to generate control signals, feedback messages, or adjustment instructions based on the recognized emotion.

The term “real-time feedback” refers to information, guidance, responses, or reactions that are generated and presented to the candidate during an ongoing interview session with a latency that is short enough for the candidate to perceive the information, guidance, responses, or reactions as immediate or near-immediate in the context of the same session.

The term “questions and exchanges that are difficult to ask in person” refers to questions or conversational interactions that human interviewers are likely to avoid or hesitate to use in face-to-face situations due to their sensitive, personal, or potentially uncomfortable nature, including questions aimed at eliciting a candidate's honest motivations, doubts, or concerns.

The term “honest opinions” refers to candid, unfiltered expressions of a candidate's true thoughts, motivations, preferences, concerns, or evaluations regarding a company, role, or working environment.

The term “emotional state of the candidate” refers to a condition or profile representing one or more emotions of the candidate at a particular time or over a particular period during the interview, the condition or profile being derived from one or more analysis results of the candidate's answers.

The term “interview question content” refers to the textual or semantic substance of one or more questions presented to the candidate during the interview, including the topics, wording, tone, and level of difficulty of the questions.

The term “interview question order” refers to a sequence in which multiple interview questions are presented to the candidate, including any changes in sequencing such as insertion, omission, or reordering of questions.

The term “adjust the interview” refers to a modification of at least one of the interview question content, the interview question order, the timing, or the style of feedback during an interview, the modification being performed based on a generated prompt text or on an analysis of the candidate's emotional state.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

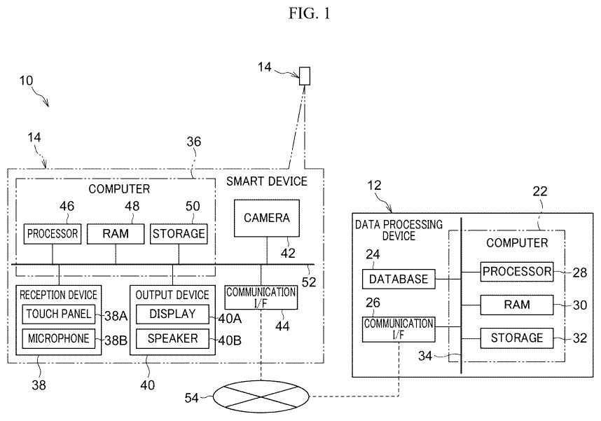

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

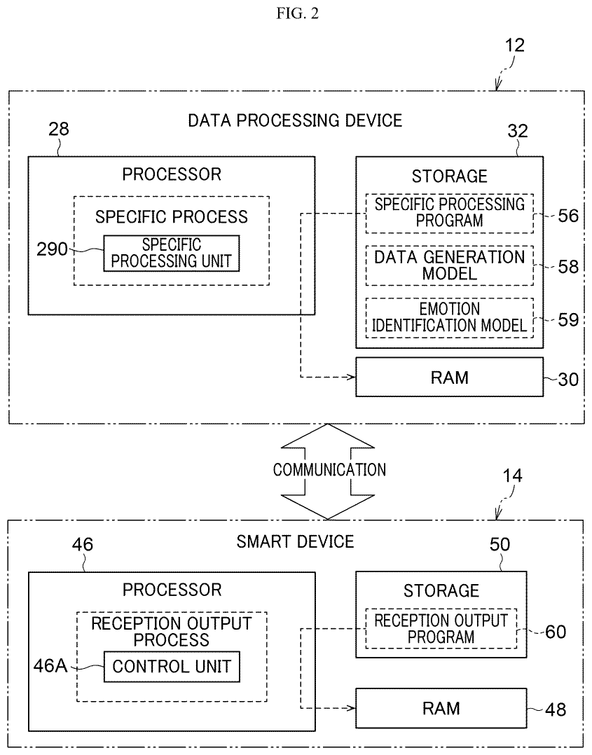

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional interview support systems mainly digitize scheduling, video conferencing, and form-based scoring, but they do not fundamentally improve how a computing system understands and evaluates candidate responses in view of an organization's values and behavioral guidelines. In particular, several technical problems remain unresolved.

First, existing systems typically treat organizational philosophy and culture as static text or simple tags attached to questions and answers. A processor in such systems generally does not construct a machine-usable, contextual knowledge representation of these values. As a result, the system cannot dynamically adapt question generation or answer analysis to nuanced organizational contexts. This leads to a technical limitation: the computing system cannot effectively condition its natural language processing pipeline on rich, organization-specific semantics.

Second, many systems rely on predefined question banks and fixed evaluation rules. Even if a generative AI model is incorporated, it is often invoked in an ad hoc manner, without systematic prompt design or structured interaction between stored corporate information and the model. The processor typically sends generic prompts to a generative model without retrieving or injecting the most relevant portions of organizational text at run time. This lack of retrieval-augmented generation causes suboptimal use of computing resources and yields interview content that is poorly aligned with the organization's values. From a computer-technology standpoint, the system fails to exploit vector representations and search structures to improve context selection and model conditioning.

Third, conventional systems do not provide a technical mechanism for dynamically generating follow-up questions based on a combination of (i) the original question, (ii) the candidate's response, and (iii) an internal knowledge context of organizational values. The absence of such a mechanism forces the system to rely on static flows or simple rule-based branching. This reduces the adaptability of the interaction engine and limits the ability of the processor to perform context-sensitive, iterative natural language generation in real time.

Fourth, most systems provide only coarse-grained scoring or simple keyword-based analysis of candidate responses. They do not leverage a structured sequence of prompt sentences that explicitly directs a generative AI model to output machine-readable evaluation information, such as value suitability indices and behavioral characteristic indices. Without such structured prompts and outputs, the processor cannot reliably compute, aggregate, and visualize fine-grained metrics in a way that is optimized for downstream computation and user interface rendering.

Accordingly, there is a need for a technical architecture in which a processor: (i) automatically acquires and structures descriptive information regarding organizational values and behavioral guidelines from multiple information resources; (ii) constructs and maintains a knowledge context for a generative AI model, including retrieval mechanisms based on embedding vectors; (iii) generates prompt sentences that systematically control the behavior of the generative AI model for question generation, follow-up question generation, and answer evaluation; and (iv) transforms raw natural language interactions into structured evaluation information and report data. By addressing these technical issues, the invention aims to improve the way computing systems process, store, retrieve, and utilize organization-specific natural language content in interview workflows, thereby improving the technical field of computer-implemented interview support and natural language processing systems.

The specific processing by the specific processing unit 290 of the data processing device 12 in Example 1 is realized by the following means.

The present invention provides a server comprising a processor and a storage device, the processor being configured to execute instructions which cause the processor to acquire, via a communication interface, document data from public and non-public information resources, analyze the document data to extract descriptive information regarding organizational values and behavioral guidelines, structure the descriptive information into text segments, and store the structured descriptive information in the storage device; generate, based on the structured descriptive information or summary information thereof, a first prompt sentence for causing a generative AI model to form a knowledge context regarding the organizational values and behavioral guidelines, and transmit the first prompt sentence together with at least part of the structured descriptive information to the generative AI model to obtain and maintain the knowledge context; generate, based on the knowledge context, a second prompt sentence for generating an interview question list, transmit the second prompt sentence to the generative AI model to obtain the interview question list, and store the interview question list in the storage device; control a terminal device to present the interview question list to an applicant, receive response data from the terminal device, and store the response data as interview session information in the storage device; generate, based on the interview session information and the knowledge context, a third prompt sentence for causing the generative AI model to output evaluation information including at least one of a value suitability index and a behavioral characteristic index, transmit the third prompt sentence and at least part of the interview session information to the generative AI model to obtain the evaluation information, and store the evaluation information in the storage device; and generate report information that visualizes an evaluation result regarding organizational suitability of the applicant based on the evaluation information and provide the report information via a display interface or a notification interface. This enables a computing system to construct and exploit an organization-specific knowledge context for a generative AI model, to generate and adapt interview questions and follow-up questions in real time, and to transform natural language responses into structured evaluation metrics and visual reports in a technically efficient and scalable manner.

The term “processor” refers to a hardware-based information processing unit, such as a central processing unit or other execution circuitry, configured to execute instructions to perform data acquisition, analysis, generation, storage, retrieval, and control operations in the system.

The term “storage device” refers to a non-transitory computer-readable medium, such as a magnetic disk, optical disk, solid-state memory, or other data storage apparatus, configured to store programs, descriptive information, question lists, response data, evaluation information, report information, and other digital data.

The term “information resource” refers to any data source accessible by the system, including public information sources, such as network-accessible content servers, and non-public information sources, such as enterprise document repositories, from which document data relating to organizational values and behavioral guidelines can be acquired.

The term “document data” refers to digital data representing textual content or mixed media content, including markup documents, text files, presentation files, word-processing files, and portable document format files, that contain descriptive information regarding organizational values and behavioral guidelines.

The term “descriptive information” refers to natural language content and related data that describe or specify organizational values, organizational philosophy, behavioral guidelines, or cultural characteristics of an entity.

The term “organizational values” refers to fundamental principles, priorities, or value axes that an organization adopts as a basis for decision-making, behavior, and evaluation of members.

The term “behavioral guidelines” refers to normative statements, rules, or recommended practices that indicate expected behaviors, attitudes, and interaction patterns for members of an organization.

The term “text segment” refers to a unit of textual data, such as a sentence, paragraph, or passage, obtained by dividing descriptive information for purposes of analysis, storage, retrieval, or processing by a generative AI model.

The term “summary information” refers to a condensed representation of descriptive information, including an abstract or shortened text, that preserves principal meanings or features of the underlying organizational values and behavioral guidelines.

The term “generative AI model” refers to a machine learning-based inference model that processes input data including prompt sentences and context information and outputs generated content such as natural language text, questions, or evaluation information, based on learned statistical relations.

The term “prompt sentence” refers to a sequence of symbols including natural language text and optional formatting or control tokens, provided as an input to a generative AI model, that specifies a task, constraints, or desired output format for the model.

The term “knowledge context” refers to information, including descriptive information, summary information, and related metadata or embeddings, provided to or maintained for a generative AI model so that the model's output is conditioned on organizational values and behavioral guidelines.

The term “interview question list” refers to a structured collection of questions, including identifiers and content of the questions, generated based on the knowledge context for use in conducting an interview with an applicant.

The term “interview question group” refers to a subset or logical grouping of questions within an interview question list, associated with particular evaluation objectives, competencies, or topics.

The term “terminal device” refers to any user-side computing apparatus, including a client computer, mobile terminal, tablet terminal, or other user interface device, configured to communicate with the server, display questions, and transmit response data.

The term “applicant” refers to a person who participates in an interview session via a terminal device and provides response data to interview questions for purposes of evaluation in relation to an organization.

The term “virtual interview” refers to an interaction session in which interview questions are presented to an applicant via a terminal device and response data is acquired electronically, without requiring physical co-location of the interviewer and the applicant.

The term “response data” refers to information representing answers or reactions of an applicant to interview questions, including natural language text, transcribed speech, or other structured or unstructured content.

The term “interview session information” refers to data associated with at least one virtual interview, including response data, question identifiers, timestamps, session identifiers, and other metadata relating to an interview session.

The term “evaluation information” refers to data generated by analysis of interview session information and the knowledge context, including at least one of numerical indices, categorical labels, or explanatory text regarding suitability or behavioral characteristics of an applicant.

The term “value suitability index” refers to a metric, such as a numerical score or categorized indicator, representing a degree of alignment between an applicant's responses and the organizational values defined in the knowledge context.

The term “behavioral characteristic index” refers to a metric representing the presence, strength, or quality of specific behavioral traits of an applicant, such as collaboration, leadership, communication, or proactivity, inferred from response data.

The term “report information” refers to structured data and generated content that summarize, aggregate, or visualize evaluation information, including scores, indices, explanations, and graphical elements for presentation to a user.

The term “hiring person” refers to a user, such as a recruiter or decision-maker, who accesses report information through an interface in order to consider or determine an employment-related decision.

The term “display device” refers to any output apparatus capable of visually presenting information, including a display panel, monitor, or graphical user interface rendered on a terminal device.

The term “notification device” refers to a component or system that transmits notifications, alerts, or messages to a user, including electronic mail systems, messaging systems, push notification services, or similar communication mechanisms.

The term “public information source” refers to a data source accessible over a communication network without individual authorization specific to a given organization, such as a publicly accessible web server.

The term “non-public information source” refers to a data source for which access is restricted by authentication or authorization specific to an organization, such as an internal file server or enterprise document management system.

The term “communication network” refers to a wired or wireless data transmission infrastructure, including local area networks, wide area networks, and packet-switched networks, through which the server communicates with information resources and terminal devices.

The term “embedding vector” refers to a numerical vector representation of a text segment or other data element, computed by an embedding algorithm or model, for use in similarity search, clustering, or retrieval operations.

The term “search structure” refers to a data organization, such as an index, table, or vector database, configured to store embedding vectors or related metadata and to support retrieval of relevant text segments based on similarity measures.

The term “follow-up question” refers to a question generated after receipt of an applicant's prior response, designed to further explore or clarify information, and produced based on at least an original question, the response data, and the knowledge context.

The term “evaluation result” refers to an outcome derived from evaluation information, including overall judgments, aggregated scores, classifications, or recommendations regarding the suitability of an applicant for an organization.

The term “display interface” refers to a software or hardware interface through which the server outputs report information for visual presentation on a display device.

The term “notification interface” refers to a software or hardware interface through which the server controls a notification device to transmit report information or summary data to a user.

In one embodiment, a server, a plurality of terminals, and users cooperate to implement the invention. The server includes at least one processor, a main memory, a non-transitory storage device, a network interface, and a display or notification interface. The terminals include at least one processor, a memory, a user interface unit such as a touch panel or keyboard, and a network interface. The users include applicants who respond to interview questions and hiring personnel who review report information.

The server executes an interview support program stored in the storage device. The interview support program is implemented, for example, on top of an operating system such as a general-purpose server operating system, and may use middleware such as a web application framework. The server uses a generative AI model provided as a network-accessible service, and in one embodiment the generative AI model corresponds to a transformer-based neural network having multiple self-attention layers, feed-forward layers, and positional encoding mechanisms. The server communicates with the generative AI model via an application programming interface over a communication network.

The server acquires document data representing organizational values and behavioral guidelines from information resources. The server uses a network interface and a communication protocol such as HTTP to retrieve markup documents from public information sources, and uses an application programming interface or file access protocol such as a cloud storage API to retrieve enterprise documents from non-public information sources. The server uses parsing libraries, such as an HTML parser and document conversion tools, to convert heterogeneous document formats into plain text. The server segments the plain text into text segments, such as sentences or paragraphs, and stores the text segments in the storage device as descriptive information.

The server generates numerical vector representations, referred to as embedding vectors, from individual text segments. The server uses a feature extraction model, such as a pre-trained embedding model based on a transformer encoder, that maps tokenized text segments into fixed-length real-valued vectors. The server stores the embedding vectors in a search structure such as a vector index implemented in a database. The search structure supports similarity search based on a distance metric, for example cosine similarity or Euclidean distance. By using the embedding vectors and the search structure, the server can identify, with lower computational cost than exhaustive string matching, a subset of text segments that are semantically most relevant to a later query.

The server forms a knowledge context used to condition outputs of the generative AI model. The server uses descriptive information and summary information to create the knowledge context. In one embodiment, the server generates summary information by submitting a prompt sentence and a set of text segments to the generative AI model. The generative AI model, implemented as a multi-layer transformer with attention heads and learned word-piece embeddings, performs tokenization, multi-head self-attention, linear transformations, non-linear activation functions, and layer normalization to generate a summarized text. The server stores the summarized text as part of the knowledge context.

The server generates a system-level prompt sentence that defines the role of the generative AI model and specifies that the model should base its outputs on the organizational values and behavioral guidelines. For example, the server may generate the following prompt sentence: “You are a generative AI model acting as a virtual interviewer and evaluator for an organization. You must base your questions and evaluations on the following organizational values and behavioral guidelines: [insert summary text here]. Always generate interview questions and evaluations that reflect these values and expected behaviors.”

The server stores this system-level prompt sentence in the storage device as part of the knowledge context. The server uses this stored prompt in combination with retrieved text segments when interacting with the generative AI model.

The server generates interview question lists using the knowledge context. The server first identifies a competency or topic, such as teamwork or leadership, associated with a particular interview. The server retrieves, via the search structure, a subset of text segments having the highest similarity scores to the competency and to general phrases like “collaboration” or “initiative.” The server concatenates these text segments and the system-level prompt sentence and then generates a user-level prompt sentence instructing the generative AI model to output a specified number of questions. An example of such a user-level prompt sentence is:

“Based on the organizational values and behavioral guidelines described above, generate 10 behavioral interview questions that assess the candidate's teamwork and collaboration. The questions should implicitly reflect our values of mutual respect, proactive communication, and cross-functional cooperation, and should encourage the candidate to describe specific past experiences. Output the questions as a numbered list.”

The server sends the system-level prompt sentence and the user-level prompt sentence, along with the relevant text segments, to the generative AI model. The generative AI model internally tokenizes the inputs into token sequences, applies learned embeddings, and processes the sequences through multiple transformer layers that compute attention scores, weighted sums of representations, and non-linear projections. The outputs are decoded as tokens corresponding to natural language questions. The server receives the generated questions, performs consistency checks such as verifying the number of questions and the presence of required components, and structures the questions as records including identifiers and text fields. The server stores the structured questions as an interview question list in the storage device.

The server delivers the interview question list to a terminal used by an applicant. The terminal renders a user interface, for example using a web browser with client-side scripts. The terminal displays each question sequentially or according to a configured order. The applicant uses the terminal to input response data in textual form or via voice input that is converted to text by a speech recognition module. The terminal sends the response data, together with identifiers for the question and the interview session, to the server over the communication network.

The server receives the response data and stores it as interview session information. The server associates the response data with question identifiers, timestamps, and metadata such as language and input modality. The server can convert all response data to a common encoding and representation for uniform processing. The server may also apply linguistic preprocessing using natural language processing libraries to normalize text, such as tokenization, lemmatization, and removal of non-informative tokens.

The server optionally generates follow-up questions in real time to further explore particular aspects of an applicant's behavior. When the server determines that a follow-up is required, for example because a question is flagged for deeper exploration or because the length or content of an answer falls below a threshold, the server retrieves the original question, the response data, and relevant segments from the knowledge context using the search structure. The server creates a follow-up prompt sentence, such as:

“Based on the original question and the candidate's answer below, generate one follow-up question that digs deeper into how the candidate demonstrated the organization's values of mutual respect and proactive communication. Original question: [insert question text]. Candidate answer: [insert answer text].”

The server sends this follow-up prompt sentence, together with the system-level prompt sentence and knowledge context, to the generative AI model. The generative AI model computes attention not only within the newly provided tokens but also across the context tokens, so that the follow-up question references the specific values and guidelines. The server receives the generated follow-up question and transmits it to the terminal for display to the applicant.

The server generates evaluation information describing the applicant's suitability. After the interview session is completed or after one or more answers are stored, the server retrieves relevant text segments from the knowledge context, including descriptions of organizational values and typical behavioral examples. The server then constructs evaluation prompt sentences that specify explicit scoring tasks and output formats. An example evaluation prompt sentence is:

“You are a generative AI model evaluating a candidate's answer for culture fit at an organization. The organizational culture emphasizes mutual respect, proactive communication, and accountability. Question: [insert question text]. Candidate's answer: [insert answer text]. Tasks: 1. Rate the candidate's alignment with the culture on a scale from 1 to 5. 2. Provide a 3-5 sentence explanation of your rating. 3. List 3-5 key behavioral indicators demonstrated in the answer (for example, collaboration, initiative, ownership). Return the results in a structured form with fields: score, explanation, and indicators.”

The server combines the evaluation prompt sentence with the system-level prompt sentence and the summary text of the knowledge context and sends them to the generative AI model. The generative AI model uses its internal neural network weights, which have been optimized by prior training with a gradient-based algorithm and a loss function such as cross-entropy, to infer a response that conforms to the specified structure. The server parses the response, extracts the score, explanation, and indicators, and stores these as evaluation information in the storage device.

The server aggregates evaluation information over multiple questions and sessions. The server may compute weighted averages of scores and may apply deterministic rules to combine behavioral indicators into composite indices, such as a value suitability index and a behavioral characteristic index. The server uses data structures such as tables or key-value pairs to represent the aggregated data. The aggregation algorithm is deterministic and separate from the generative AI model, ensuring that the same score inputs yield the same overall indices.

The server generates report information for hiring personnel. The server defines layout templates containing sections for overall scores, graphs, tables of questions and answers, and narrative summaries. The server may use another prompt sentence to request that the generative AI model convert the raw evaluation information into a concise narrative that is easier for humans to understand, for example:

“Using the following evaluation data (scores, explanations, and indicators), create a concise professional summary of this candidate's culture fit and teamwork capability for an internal hiring report. Emphasize strengths and potential concerns, and keep the length under 300 words. [insert evaluation data here].”

The server embeds the narrative summary into the report template and generates visual elements using a chart rendering library. The server then exposes the report information through a web interface or sends a notification via an electronic message. A terminal used by a hiring person receives and displays the report information, enabling the hiring person to view detailed evaluation results.

The server achieves technical improvements over systems that merely automate manual processes. By using embedding vectors and a search structure, the server reduces the amount of data that must be sent to the generative AI model, thereby reducing communication bandwidth and latency, while still providing highly relevant context. This selective context injection improves the quality and consistency of generated questions and evaluations because the generative AI model receives focused, semantically relevant information rather than full, noisy documents. Furthermore, by using structured prompt sentences that define explicit output formats and scoring criteria, the server enables deterministic parsing of model outputs and reduces post-processing errors, thereby improving reliability and processing speed.

The server also improves computer technology by changing how the generative AI model is utilized. Instead of a simple, one-shot text generation, the server orchestrates multiple types of prompt sentences—system-level, question-generation, follow-up, and evaluation prompts—each associated with different modules and processing objectives. The server uses non-conventional, rule-based logic to decide when to trigger follow-up question generation, how to compose the context for evaluation, and how to aggregate metrics. These control flows and rule-based decisions implement a non-standard use of generative models that is tailored for machine-executable scoring and retrieval, not merely for human consumption. The generative AI model used by the server has been trained using a supervised or semi-supervised learning process on large-scale corpora. During training, the model receives token sequences and predicts subsequent tokens, and a loss function such as cross-entropy is minimized by adjusting the network's weight parameters via a gradient descent algorithm. In some embodiments, the model may also be fine-tuned on domain-specific texts related to interviews or organizational descriptions. The server does not retrain the model during normal operation but uses the model's learned weights and inference mechanisms in a controlled fashion via prompt sentences and structured inputs. The use of embedding vectors and retrieval mechanisms is a separate component that works in tandem with the model, enabling the server to inject the most relevant organizational context without increasing the model's parameter count, thus improving computational efficiency.

The server can adopt different variations of implementation. In one variation, the server uses a single central generative AI model for both question generation and evaluation. In another variation, the server uses a first generative AI model for generating questions, which may emphasize diversity and creativity, and a second generative AI model for evaluation, which may be fine-tuned for stability and consistency in scoring. In still another variation, the server executes part of the embedding computation locally using a light-weight encoder model, and calls a remote generative AI model only when necessary, thereby reducing network traffic and improving responsiveness.

The terminals can also vary. In one embodiment, a terminal is a smartphone running a mobile application that caches portions of the interview question list locally and uploads response data in batches, reducing network usage under unstable connections. In another embodiment, a terminal is a web client that uses a browser-based audio capture and speech recognition interface, converting spoken answers to text before sending them to the server. The terminals may provide accessibility features such as adjustable font sizes and alternative input methods, but these features are independent from the core mechanisms by which the server constructs and uses the knowledge context.

The users interact with the system through interfaces provided by the terminals. An applicant reads interview questions and enters responses, and a hiring person reads report information and may provide manual annotations. The server stores these annotations separately and may optionally use them as labeled data to adjust aggregation rules or to refine prompt sentences for improved alignment with human decisions.

By combining a generative AI model, prompt sentences, embedding-based retrieval, and structured evaluation workflows, the server, terminals, and users cooperate to create a computer-implemented interview support system that improves the quality and efficiency of natural language processing operations, reduces unnecessary data transfer, increases the precision and interpretability of evaluation metrics, and provides a technically enhanced method of handling organization-specific interview data that cannot be achieved by conventional manual procedures or simple automation alone.

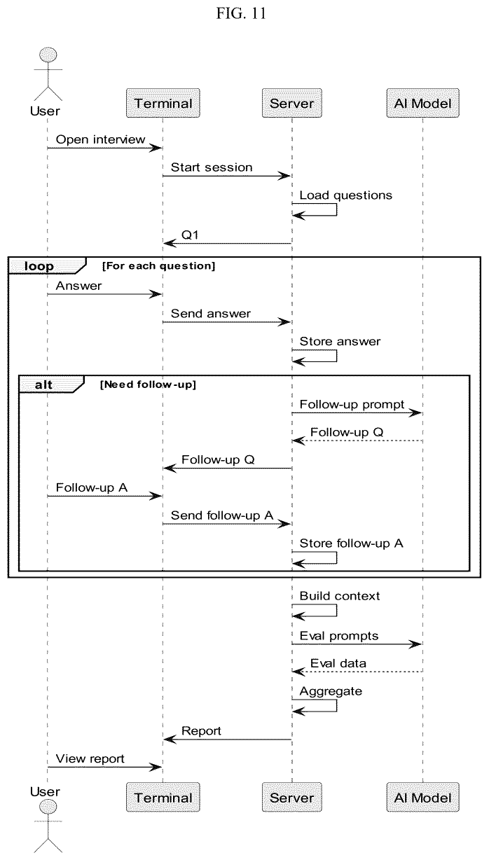

The following describes the processing flow using FIG. 11.

### Step 1:

The server acquires descriptive information regarding organizational values and behavioral guidelines from information resources.

The server receives, as input, resource identifiers such as network addresses of public content servers and paths or identifiers of non-public enterprise document stores. The server sends requests over a communication network using protocols such as HTTP or storage APIs, and obtains document data including markup documents, text files, and portable document format files. The server parses the document data using parsing software to remove markup tags and convert binary formats into plain text, and then segments the plain text into text segments such as sentences or paragraphs. The server outputs structured descriptive information in which each text segment is stored together with metadata including source, timestamp, and language, and writes this descriptive information into a storage device.

### Step 2:

The server generates embedding vectors and constructs a search structure for the descriptive information.

The server receives, as input, the text segments stored in the storage device. The server applies a tokenization algorithm to convert each text segment into a sequence of tokens and then uses a feature extraction model, such as a transformer-based encoder, to compute an embedding vector for each text segment as a real-valued vector. The server stores the embedding vectors in a vector index structure, together with references to the original text segments. The server outputs a search structure that supports similarity search based on a distance function, enabling later retrieval of text segments relevant to specific topics or prompt sentences.

### Step 3:

The server forms a knowledge context describing organizational values and behavioral guidelines.

The server receives, as input, selected text segments and corresponding embedding vectors retrieved from the search structure based on a query representing an organization or role. The server optionally computes a summary by concatenating selected text segments and generating a prompt sentence instructing a generative AI model to produce a condensed description. The server transmits the prompt sentence and the concatenated text segments to the generative AI model, and receives, as output, a summarized text. The server combines the summarized text, selected text segments, and associated metadata to form a knowledge context object, and stores the knowledge context object in the storage device.

### Step 4:

The server generates a system-level prompt sentence for controlling the behavior of the generative AI model.

The server receives, as input, the knowledge context object containing the summarized text and key descriptive information. The server builds a system-level prompt sentence that specifies that the generative AI model shall act as a virtual interviewer and evaluator and shall base its outputs on the organizational values and behavioral guidelines contained in the knowledge context. The server concatenates role instructions and the summarized text into a single prompt string. The server outputs the system-level prompt sentence and stores it as part of the configuration for subsequent interactions with the generative AI model.

### Step 5:

The server generates an interview question list using the generative AI model and the knowledge context.

The server receives, as input, the system-level prompt sentence, the knowledge context object, and interview configuration parameters such as target competencies and desired number of questions. The server retrieves, from the search structure, text segments whose embedding vectors are most similar to the target competencies. The server creates a user-level prompt sentence that instructs the generative AI model to generate a specified number of interview questions, and appends the retrieved text segments to the prompt sentence as contextual information. The server transmits the system-level prompt sentence and the user-level prompt sentence to the generative AI model, and receives, as output, natural-language questions. The server parses the output text into individual questions, assigns identifiers, and writes the resulting interview question list into the storage device.

### Step 6:

The server initiates a virtual interview session and provides questions to a terminal.

The server receives, as input, a request to start an interview session for a specific applicant, including an identifier of the interview question list. The server allocates a session identifier, retrieves the corresponding interview question list from the storage device, and generates a session object containing the questions and scheduling data. The server sends the initial portion of the interview question list and session metadata to a terminal associated with the applicant. The server outputs a session record stored in the storage device, linking the session identifier, applicant identifier, and question identifiers.

### Step 7:

The terminal presents interview questions to a user and captures response data.

The terminal receives, as input, the session metadata and the interview question list transmitted by the server. The terminal displays the first question on a user interface and waits for user input. The user reads the question and enters a response either by typing text into an input field or by speaking into a microphone. When the user uses voice, the terminal performs speech capture and applies a speech-to-text module to convert audio signals into textual data. The terminal outputs response data containing the text of the user's answer together with question identifiers and session identifiers, and sends this response data to the server over the communication network.

### Step 8:

The server stores interview session information based on received response data.

The server receives, as input, the response data from the terminal, including the applicant's answer text and associated identifiers. The server performs data normalization such as character encoding conversion and optional language detection, and then stores the normalized answer text into a session database table along with timestamps and question identifiers. The server updates the interview session record to reflect that a response has been received for a particular question. The server outputs updated interview session information that accumulates all answers provided by the user during the session.

### Step 9:

The server generates follow-up questions dynamically using the generative AI model.

The server receives, as input, the original question text, the applicant's answer from the interview session information, and the knowledge context object. The server may calculate properties such as answer length, presence of target keywords, or response latency, and compare these properties with predefined thresholds to determine whether a follow-up question is required. When a follow-up is required, the server generates a follow-up prompt sentence that includes the original question, the answer, and instructions to produce one clarifying question aligned with specific organizational values. The server transmits the system-level prompt sentence and the follow-up prompt sentence to the generative AI model, and receives, as output, a follow-up question in natural-language text. The server stores the follow-up question in the storage device, associates it with the session identifier, and transmits it to the terminal. The server outputs an updated question sequence that includes the generated follow-up question.

### Step 10:

The terminal presents follow-up questions and acquires additional responses from the user.

The terminal receives, as input, a follow-up question from the server linked to the ongoing interview session. The terminal displays the follow-up question to the user and records a new answer using text input or speech recognition in the same manner as for initial questions. The user reads the follow-up question and provides additional explanation or detail. The terminal packages the new response as response data containing the follow-up question identifier, session identifier, and answer text. The terminal outputs the additional response data to the server for storage and subsequent analysis.

### Step 11:

The server prepares evaluation input data by combining interview session information and the knowledge context.

The server receives, as input, all answer texts and associated metadata for a completed interview session, as well as the knowledge context object. The server retrieves descriptive segments from the knowledge context that are relevant to the competencies associated with each question by performing similarity search over the embedding vectors. The server constructs evaluation input structures that pair each question and answer with the most relevant context segments and the summarized description of organizational values. The server outputs structured evaluation input data for each question-answer pair, ready to be used in prompt sentences for the generative AI model.

### Step 12:

The server generates evaluation information using structured prompt sentences and the generative AI model.

The server receives, as input, the structured evaluation input data created for each question-answer pair. The server constructs evaluation prompt sentences that define tasks such as scoring alignment on a numeric scale, generating textual explanations, and identifying behavioral indicators. The server assembles, for each evaluation, a combined prompt that includes the system-level prompt sentence, the question text, the answer text, and the relevant context segments. The server transmits these combined prompts to the generative AI model, and receives, as output, structured evaluation information containing values such as scores, explanations, and lists of indicators. The server parses the outputs, validates data types and ranges, and stores the evaluation information in the storage device associated with the corresponding question-answer pairs.

### Step 13:

The server aggregates evaluation information into indices and overall scores.

The server receives, as input, evaluation information for multiple question-answer pairs belonging to an interview session. The server applies deterministic aggregation algorithms, such as weighted averaging or rule-based combinations, to compute higher-level indices including a value suitability index and multiple behavioral characteristic indices. The server may apply normalization procedures to align scores to a common scale. The server outputs aggregated evaluation data that represent the applicant's overall suitability in a form ready for report generation, and writes this aggregated data into the storage device.

### Step 14:

The server generates report information for hiring personnel.

The server receives, as input, aggregated evaluation data, individual evaluation information, and interview session metadata. The server selects a report template and populates sections with numerical indices, textual explanations, and selected excerpts of questions and answers. The server may generate a narrative summary by constructing a summary prompt sentence that instructs the generative AI model to produce a concise professional description of the candidate's strengths and potential risks based on the evaluation data. The server embeds the resulting narrative into the report template, and optionally renders graphical representations such as charts or bar graphs. The server outputs report information as structured data and formatted content, and stores or caches it for access by a terminal used by a hiring person.

### Step 15:

The terminal used by a hiring person displays report information and accepts user feedback.

The terminal receives, as input, the report information transmitted from the server. The terminal renders a user interface that displays overall indices, detailed scores per question, narrative summaries, and graphical elements. The hiring person reviews the information, scrolls through sections, and may enter comments or decisions through input fields or selection controls. The terminal packages the comments and decisions as feedback data, including identifiers linking them to the specific interview session and applicant, and transmits the feedback data back to the server. The terminal outputs the feedback data to enable the server to store human annotations and decision outcomes.

### Step 16:

The server stores feedback data and optionally refines control parameters and prompt sentences.

The server receives, as input, feedback data from the terminal used by the hiring person, including comments, final decisions, and optionally manual adjustments to scores. The server writes this feedback data into the storage device associated with the relevant interview session and applicant profile. The server may analyze patterns in the feedback over multiple sessions to adjust aggregation weights, thresholds for generating follow-up questions, or phrase structures of prompt sentences. The server outputs updated control parameters and stored configuration data, thereby gradually tuning the system behavior to better align with observed evaluation outcomes while maintaining the overall processing flow based on the generative AI model and prompt sentences.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented interview systems primarily digitize question presentation and answer recording, but they do not substantially improve the underlying information processing that determines how interviews are structured, how answers are interpreted, or how organizational fit is evaluated. In typical systems, interview scenarios are pre-defined by human operators, natural language answers are stored as unstructured text or simple keyword counts, and evaluation rules are static and generic. As a result, the processing architecture remains rigid: the system cannot adapt its behavior based on an organization's specific philosophy and culture, cannot dynamically adjust interview content in response to candidate behavior, and cannot consistently transform raw language input into structured, organization-aligned evaluation data.

Furthermore, in conventional architectures, natural language processing is applied in isolation from organization-specific semantic context. Generic models or rule sets are used without being systematically conditioned on organization-level information such as values, mission statements, or behavioral expectations. This leads to low precision in assessing alignment between candidate answers and organizational philosophy, and forces downstream evaluators or applications to compensate through manual review. From a computer technology standpoint, this means that the integration between context acquisition (organizational documents), model configuration (prompt design and context feeding), and runtime control of the interview (question generation, sequencing, and adaptation) is fragmented and not optimized as a coherent processing pipeline.

In addition, existing systems generally lack a mechanism by which a server-side processor coordinates a generative AI model, a speech recognition engine, and a visual terminal in a tightly coupled feedback loop. In many systems, question presentation, speech-to-text conversion, and answer scoring are separate modules with weak or ad hoc interfaces, resulting in latency, inconsistent state management, and limited ability to perform real-time adaptation. For example, the system typically does not use intermediate analysis results (such as inferred intent or emotional state) to modify subsequent processing steps such as prompt construction or question ordering. This architecture restricts the capability of the system to function as an adaptive, intelligent interview engine rather than a simple digital questionnaire. Moreover, known systems do not adequately exploit the programmability of prompt sentences used with generative AI models. Prompt sentences are often static templates crafted manually for specific use cases, and the server does not algorithmically generate or update such prompt sentences based on real-time analysis of candidate responses, nor based on machine-readable representations of organizational philosophy and culture. Consequently, the generative AI model is under-utilized: it operates on generic instructions, provides non-standardized output, and cannot be reliably integrated into structured evaluation and control logic within the broader system.

Accordingly, there is a need for an improved computer-implemented interview system in which a server-side processor: (i) automatically acquires and structurally represents organizational philosophy and culture from various information sources; (ii) uses such representations to configure and condition a generative AI model through dynamically generated prompt sentences; (iii) orchestrates a sequence of processing steps including question generation, speech recognition, natural language analysis, and evaluation; and (iv) uses analysis results to dynamically control subsequent interview content and flow. By addressing these limitations at the system and algorithmic levels, the invention aims to improve the functioning of the computer system itself, enabling more accurate, context-aware, and adaptive processing of natural language interviews with reduced manual intervention and improved consistency.

The specific processing by the specific processing unit 290 of the data processing device 12 in Application Example 1 is realized by the following means.

The present invention provides a server comprising a processor configured to analyze character information acquired from an information source related to an organization and extract information regarding a philosophy and a culture of the organization, to generate a prompt sentence for causing a generative AI model to learn the philosophy and the culture of the organization based on the extracted information and to input the prompt sentence and the extracted information into the generative AI model so as to construct the generative AI model configured to perform dialogue generation and evaluation specialized for the organization, to input interview conditions including a job type and an evaluation viewpoint into the generative AI model and to cause the generative AI model to generate interview questions to be presented to a candidate based on the interview conditions and the philosophy and the culture of the organization, to transmit the interview questions to a terminal device having a visual display function and to cause the terminal device to visually present the interview questions to the candidate, to receive from the terminal device character information obtained by converting voice information of the candidate into the character information by using a speech recognition technique, to input the character information representing an answer of the candidate into the generative AI model and to analyze a meaning and an intention of the answer by natural language processing so as to generate evaluation information indicating a degree of consistency of the answer with the philosophy and the culture of the organization, and to output the evaluation information to at least one of the terminal device and an evaluator display device and present an evaluation result regarding suitability of the candidate. This enables the computer system to operate as an integrated, context-aware interview engine in which acquisition of organization-specific information, configuration of the generative AI model through dynamically generated prompt sentences, real-time processing of multimodal candidate input, and adaptive control of interview content are executed as a unified processing pipeline, thereby improving the technical performance of natural language analysis and evaluation, reducing reliance on static rule sets and manual configuration, and providing consistent, structured assessment outputs that are directly aligned with the organization's philosophy and culture.

The term “processor” refers to a hardware computing unit or a combination of hardware computing units configured to execute machine-readable instructions, perform arithmetic and logic operations, and control data flow within the system, including a central processing unit, a microcontroller, or a computing core of an integrated circuit.

The term “system” refers to an assembly of hardware and software components, including at least a server-side computing apparatus and one or more terminal devices, that cooperate to perform the interview processing described in the present specification.

The term “server” refers to a computing apparatus, typically including at least one processor and a memory, configured to provide centralized processing, storage, and control functions, and to communicate with one or more terminal devices over a communication network.

The term “terminal device” refers to a client-side electronic apparatus having at least an input function and a display function, such as a wearable display device, a head-mounted display device, a portable communication device, or a computing terminal, which presents information to a candidate and acquires input from the candidate.

The term “visual display function” refers to a capability of a terminal device to render text, graphics, or other visual information on a display unit, such as a screen, a projection surface, or an optical combiner, so that the information can be visually perceived by a user.

The term “generative AI model” refers to a machine-implemented statistical or neural network model configured to generate new text or other data in response to input data or instructions, including but not limited to large language models and sequence-to-sequence models that can produce natural language output.

The term “prompt sentence” refers to text data or a set of text data provided as input to a generative AI model, the text data specifying a role, an instruction, a context, or constraints for the generative AI model so as to control or influence the content or style of an output generated by the generative AI model.

The term “organization” refers to an entity such as a company, an enterprise, an institution, or an association having at least one defined objective and internal rules, and within which a philosophy and a culture are established.

The term “philosophy of the organization” refers to conceptual information that expresses fundamental values, missions, visions, or guiding principles declared or adopted by the organization.

The term “culture of the organization” refers to information that expresses characteristic practices, behavioral norms, conventions, and implicit or explicit expectations shared within the organization.

The term “information source related to an organization” refers to any data repository or content source that describes or implies the philosophy or the culture of the organization, including, for example, web content, electronic documents, internal manuals, policy documents, or database records.

The term “character information” refers to data represented in a symbolic textual form, including characters, letters, numerals, symbols, and encoded text strings that can be processed by a computer system.

The term “voice information” refers to data representing audible sound produced by a person, including analog voice signals and digitized audio data obtained by sampling and encoding the analog voice signals.

The term “speech recognition technique” refers to a software-implemented or hardware-implemented process that converts voice information into character information by analyzing acoustic features and mapping the features to corresponding linguistic units.

The term “interview conditions” refers to configuration information that specifies parameters for an interview scenario, including at least a job type, a role of a candidate, and one or more evaluation viewpoints or criteria.

The term “evaluation viewpoint” refers to an aspect or dimension along which a candidate is to be evaluated, such as suitability for a role, alignment with organizational values, communication ability, or mindset regarding customer service.

The term “interview question” refers to a unit of natural language text or equivalent information that is generated by the generative AI model and is intended to be presented to a candidate to elicit a response relevant to the evaluation viewpoint.

The term “candidate” refers to a person who participates in an interview session and provides responses to interview questions, typically for assessment with respect to participation in or employment by the organization.

The term “answer of the candidate” refers to content provided by the candidate in response to an interview question, including spoken utterances that are captured as voice information and converted into character information.

The term “natural language processing” refers to one or more algorithmic techniques for analyzing, interpreting, or generating human language, including tokenization, parsing, semantic analysis, sentiment analysis, intent detection, or text classification.

The term “evaluation information” refers to structured or semi-structured data produced by the system that represents an assessment result related to the candidate, including, for example, a numerical score, a qualitative rating, an alignment measure, or explanatory text.

The term “degree of consistency” refers to a quantitative or qualitative measure indicating how closely the content, meaning, or intent of the candidate's answer matches or supports the philosophy or the culture of the organization.

The term “evaluator display device” refers to an electronic apparatus, separate from the candidate's terminal device, having a display function and configured to present evaluation information or interview results to an evaluator, such as a human interviewer or an operator.

The term “face-to-face situation” refers to an interaction environment in which a human interviewer and a candidate are directly confronting each other in person or in a real-time audiovisual communication, and in which certain questions may be socially difficult to present.

The term “candid response” refers to an answer from the candidate that reflects genuine opinions, feelings, or intentions of the candidate, rather than socially adjusted or constrained statements.

The term “emotional state” refers to a condition of affect or feeling that is inferred from the candidate's answer, such as confidence, anxiety, enthusiasm, or reluctance, as represented in a machine-interpretable form.

The term “attitude tendency” refers to a characteristic orientation or behavioral disposition of the candidate, such as cooperativeness, proactiveness, or customer orientation, inferred from the candidate's answers by analysis with the generative AI model.

The term “difficulty level of subsequent interview questions” refers to a measure of complexity, abstraction, or challenge associated with later interview questions, which can be adjusted based on prior evaluation information.

The term “order of subsequent interview questions” refers to a sequence in which interview questions are presented to the candidate, which sequence can be modified dynamically during execution of the interview.

The term “presentation timing” refers to a point in time or a temporal interval at which an interview question or evaluation information is presented to a candidate or an evaluator.

The term “dynamic control of progress of an interview” refers to a process in which the server modifies at least one of the contents, sequence, difficulty, or timing of interview questions in real time or near real time based on analysis results generated during the interview.

In one embodiment, a server, a terminal, and a user cooperate to implement the invention.

The server includes at least one processor, a main memory, a non-volatile storage device, and a network interface. The server executes an operating system such as a general-purpose server operating system and application software implementing the interview control functions. The terminal includes a wearable display device, such as smart glasses, having a display unit, a microphone, one or more sensors, a local processor, and a wireless communication interface. The user wears the terminal and interacts with the system by viewing displayed interview questions and by speaking answers.

The server uses a software stack that may include a web client library (for example, a library performing functionality similar to an HTTP client), a document parsing library (for example, a library performing functionality similar to a generic document parser), a natural language processing library (for example, a library performing functionality similar to a linguistic analysis toolkit), a vector search library (for example, a library performing functionality similar to a vector indexing engine), and client libraries for accessing a generative AI model service and a speech recognition service (for example, services providing functionality similar to a large language model API and a cloud speech-to-text API). The server stores structured data in a database system such as a relational database or a document database.

The server acquires organization-related text data from multiple sources. The server receives, as configuration input, one or more network resource identifiers and one or more document file descriptors. The server uses the web client library to send HTTP requests and to download hypertext documents or other structured digital documents. The server uses the document parsing library to convert the downloaded data as well as local documents such as portable document format files and office documents into plain text strings. The server normalizes the text by removing markup, control symbols, and boilerplate segments, and then segments the normalized text into units such as sentences and paragraphs using punctuation-based rules and learned sentence boundary models.

The server performs semantic extraction on the segmented text. The server uses a natural language processing library to perform tokenization, part-of-speech tagging, and dependency parsing. The server applies a classifier model trained to detect text segments that express organizational philosophy or culture. In one embodiment, the classifier is implemented as a neural network that takes as input contextual word embeddings and outputs a label for each sentence indicating whether it belongs to categories such as “mission,” “values,” “behavioral norms,” or “background information.” The server aggregates sentences labeled as relevant into category-specific records, for example a record for “core values” and a record for “customer service philosophy.” The server stores these records as structured entities in the database, with fields for category type, source identifier, time stamp, and original text.

The server constructs a representation for conditioning the generative AI model. The server calls an embedding service compatible with the generative AI model and requests a vector representation for each stored philosophy or culture paragraph. In a typical configuration, the embedding service implements a deep neural network that maps a sequence of tokens to a fixed-dimensional vector in a semantic space, where semantically similar paragraphs are located near each other. The server receives a floating-point vector for each paragraph and stores the vector, together with metadata, in a vector index. The server configures the vector index with an approximate nearest neighbor search algorithm such as hierarchical navigable small world graphs or product quantization to enable efficient retrieval of semantically similar paragraphs given a query vector.

The server generates a base prompt sentence for setting the behavior of the generative AI model. The server synthesizes text that defines a role and task for the model, for example:

“You are a generative AI model that creates and evaluates interview questions for assessing how well a candidate aligns with the philosophy and culture of an organization.”

The server appends to this text one or more paragraphs extracted from the organization profile, such as:
“Organization philosophy and culture:
‘We always greet customers warmly, listen carefully to their needs, and take responsibility for solving their problems with honesty and speed.’”

In another embodiment, the server constructs a prompt sentence explicitly oriented toward question generation, such as:
“You are a generative AI model that creates interview questions.
Organization philosophy and culture:
‘We always greet customers warmly, listen carefully to their needs, and take responsibility for solving their problems with honesty and speed.’
Based on this philosophy, generate 5 interview questions that assess a candidate's fit for a retail store clerk position.”

The server uses such prompt sentences as system-level or instruction-level context when calling the generative AI model.

The server configures the generative AI model to operate as a transformer-based neural network composed of multiple encoder-decoder layers. Each layer performs multi-head self-attention and feed-forward transformations with learned weight matrices. The server or an external training service has trained this model on a large corpus of text data using an objective function such as cross-entropy loss, with gradient-based optimization such as stochastic gradient descent with adaptive learning rate. In an organization-specific adaptation phase, the server performs supervised fine-tuning or prompt-based adaptation. In fine-tuning, the server constructs training pairs consisting of organization text and target outputs (for example, ideal questions or evaluation templates) and calls a training interface that updates the model's weight tensors. In prompt-based adaptation, the server does not change the core weights but instead constructs special context sequences, including the organization philosophy text and base instructions, which alter the model's internal attention patterns at inference time. In both cases, the server controls parameters such as temperature, maximum token length, and top-k or nucleus sampling rates to stabilize output patterns and reduce variance.

The server also implements a runtime retrieval-augmented generation mechanism. When the server later needs to generate questions or analyze answers for a particular evaluation viewpoint (for example, customer service or teamwork), the server encodes the viewpoint text as an embedding vector and queries the vector index to retrieve the most relevant philosophy and culture paragraphs. The server inserts these retrieved paragraphs into the context section of a new prompt sentence. This mechanism ensures that the model's attention is concentrated on organization-specific content rather than generic patterns, thereby improving alignment between generated questions or evaluations and the actual organizational philosophy.

The terminal operates as a client device for presenting interview questions and capturing candidate responses. The terminal runs a client application that includes a graphical user interface module, a communication module, and an audio capture module. The terminal uses an operating system-provided graphics API to render text or graphical overlays into the display area of the smart glasses. The terminal continuously maintains a secure communication session with the server, exchanging messages encoded in a structured text protocol. When the terminal receives from the server a list of interview questions, the terminal stores the list in its local memory and displays one question at a time to the user as an overlaid text object.

The user wears the terminal and initiates an interview session by performing a predefined interaction, such as selecting a start control or issuing a voice command. The user reads the interview questions presented in the field of view of the smart glasses and responds verbally in natural language. The terminal uses a microphone driver and an audio buffer in memory to capture the analog sound and digitize it into audio frames with a specified sampling rate and sample size. The terminal sends the audio data to a speech recognition service over a network connection.

The server cooperates with a speech recognition engine that may be provided as a separate service. The speech recognition engine uses acoustic models and language models, such as deep neural networks trained on audio-text pairs, to map audio feature vectors to sequences of tokens. The engine outputs recognized text strings for each answer. The terminal receives this text and forwards the text to the server, or the speech recognition engine directly transmits recognized text to the server depending on configuration.

The server structures the candidate's responses as answer records. Each record includes fields for question identifier, raw text of the answer, time stamps, and possibly intermediate confidence scores from the speech recognizer. The server normalizes the text by applying tokenization, lowercasing rules, and removal of disfluencies. The server then analyzes the normalized text by using the generative AI model in analysis mode. For analysis, the server constructs a prompt sentence such as:
“You are a generative AI model that evaluates interview answers.
Organization philosophy and culture:
‘We always greet customers warmly, listen carefully to their needs, and take responsibility for solving their problems with honesty and speed.’
Interview question:
‘How would you handle a situation where a customer is upset about a long wait time?’
Candidate's answer:
‘I would first apologize for the wait, explain the reason briefly, and then try to serve them as quickly as possible while staying polite.’
Evaluate how well this answer aligns with the organization's philosophy. Output a JSON-like structure with: score (1-5), strengths, concerns, and a 2-3 sentence summary.”

Although the server may internally use a structured format for the output, the prompt is presented to the generative AI model as a plain text instruction sequence. The generative AI model processes the concatenated tokens of philosophy text, question text, answer text, and instructions, using its multi-head attention and feed-forward layers to compute contextualized representations. In its output layer, the model generates tokens that correspond to a structured evaluation. Because the server has constrained the instruction format, the model output contains fields such as a numerical score and short bullet descriptions. The server parses the output text using pattern matching or a lightweight parser and stores an evaluation object in the database. This evaluation object contains numeric and textual fields for alignment score, strengths, concerns, and summary.

The server further derives higher-level evaluation information such as an emotional state or attitude tendency. In one embodiment, the server uses a secondary classifier implemented as a neural network that takes as input text embeddings or intermediate representations of the answer and outputs scores for emotional dimensions (for example, confidence, empathy, defensiveness) or attitude attributes (for example, cooperativeness, customer orientation). The classifier can be trained separately using supervised labels. The server merges these scores with the generative AI model's structured evaluation into a unified evaluation record. This record uses a defined schema that allows later modules to perform deterministic operations, such as comparing scores to thresholds or computing weighted aggregates.

The server uses the evaluation information to generate follow-up prompt sentences for dynamic interview control. In one embodiment, the server executes rule-based logic defined over the evaluation record. For example, if the alignment score is below a certain numeric threshold or if the empathy score is low, the server forms a prompt sentence that requests more probing questions. An example prompt sentence is:
“Based on the following evaluation information:
alignment score: 2 out of 5,
empathy: low,
Generate 3 follow-up interview questions that explore why the candidate may not prioritize listening to customers.”

In another configuration, the server includes in the prompt both previous questions and answers and instructs the generative AI model to generate a sequence of questions that gradually increase in difficulty or specificity. By explicitly encoding evaluation results into the prompt, the server forces the model to consider the candidate's prior performance as context, resulting in a customized question sequence that is not simply a static script.

The server improves computer technology in several ways. First, the server introduces a structured pipeline that integrates retrieval-augmented conditioning of a generative AI model, speech-to-text conversion, and dynamic prompt generation based on real-time evaluation data. This architecture reduces the need for bulky, static rule sets and allows the server to reuse a single core model across multiple organizations while still providing organization-specific behavior. By storing organization philosophy and culture as vectorized records and by using approximate nearest neighbor search, the server reduces latency when retrieving context, which directly lowers response time for question generation and answer analysis. This leads to a measurable improvement in processing speed compared to systems that load large, unindexed text blocks for every inference.

Second, the server enhances evaluation accuracy by transforming unstructured natural language answers into structured evaluation data aligned with organization-specific semantics. The server uses a combination of transformer-based language modeling, supervised classification, and retrieval-based context injection to map answers into multi-dimensional scores. This approach reduces noise from generic interpretation and allows the system to consistently apply organization-dependent criteria. As a result, the system reduces error rates in alignment assessment, for example reducing false positives where a superficially positive answer does not in fact match the organization's stated values.

Third, the server improves data management by defining explicit data structures for organization profiles, question sets, answer records, and evaluation records. Each structure is indexed by identifiers and includes time stamps and metadata. This enables efficient querying, version control, and audit logging. When multiple interviews are conducted, the server can compute statistics and refine internal thresholds without manual reconfiguration. The modular data structures also permit distributed storage, thereby reducing congestion on single storage nodes and improving scalability.

Fourth, the server reduces communication load between server and terminal by shifting certain operations to the server side and by transmitting only essential information. The terminal sends compressed audio or already recognized text, and the server sends short question texts and evaluation summaries, rather than large unstructured logs. The retrieval-augmented generation ensures that only compact identifiers or embeddings are transferred in certain modes. This design minimizes bandwidth consumption and supports deployment over wireless networks with limited capacity.

The server introduces a non-conventional processing sequence compared to simple human task automation. Rather than simply replacing a human interviewer with an automated script, the server executes specific computational procedures that are not typically performed by humans, such as high-dimensional vector search, transformer layer inference, and quantitative scoring across multiple latent dimensions. The server enforces explicit rules when constructing prompt sentences, for example enforcing that each prompt contains a defined section for philosophy text, question text, answer text, and output schema. These rules are implemented as programmatic constraints and templates that control the generative AI model's behavior to make output machine-parsable and consistent over time.

In alternative embodiments, the server can employ different model architectures while maintaining the same functional pipeline. For example, the generative AI model can be a bidirectional encoder-only language model combined with a separate decoder, or an encoder-decoder transformer trained specifically for question generation and answer evaluation. The server can modulate attention patterns by inserting special control tokens into the prompt sentence. The embedding encoder can be replaced by a convolutional neural network or a recurrent network that outputs sentence-level vectors. The speech recognition component can run on the terminal itself if the terminal has sufficient computational capacity, thereby reducing network latency and improving responsiveness.

In another embodiment, the server can operate with multiple terminal types, such as a tablet computer, a desktop display, or a mobile phone. In such cases, the terminal still functions as a client device with a visual display function and an audio capture function, and the server still performs the core analysis and evaluation. The same data structures and algorithms can be reused, and only the user interface layer is adapted to the form factor of the terminal. The server can also present evaluation results not only to the candidate but also to a separate evaluator through an evaluator display device, which may be a workstation or laptop. The evaluator can view per-question scores and generated summaries in real time or after the interview.

The system is thus configured so that the server, by coordinating the generative AI model, the speech recognition technique, and the terminal, provides an integrated, technically improved environment for adaptive, organization-specific interview processing. The server's control of data flow, model conditioning, and dynamic prompt construction yields faster processing, more accurate alignment evaluation, lower communication load, and structured outputs that cannot be achieved by mere human substitution or by generic, static interview software.

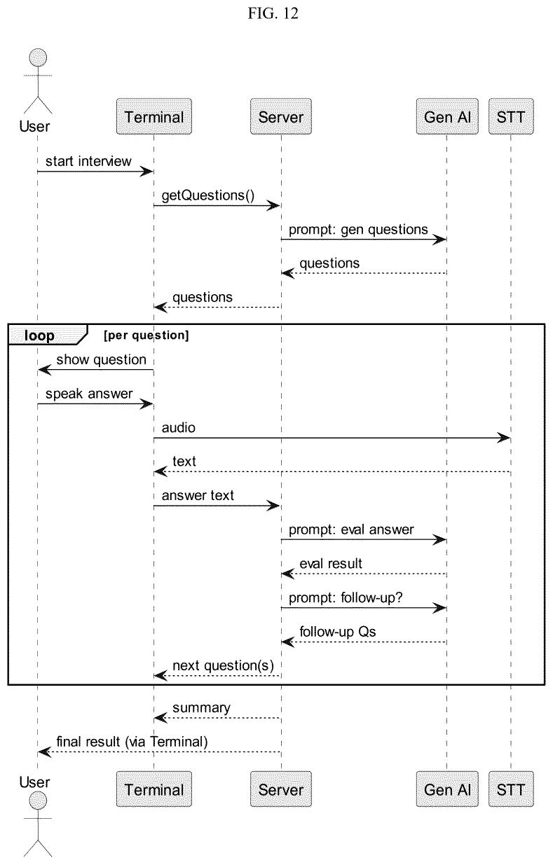

The following describes the processing flow using FIG. 12.

### Step 1:

Server receives organization information sources as input.

Server accepts, through a configuration interface or API, one or more network resource identifiers and document file descriptors as input.

Server uses an HTTP client library to send HTTP requests to the specified network resources and downloads hypertext documents as response data.

Server reads binary content of local document files such as electronic documents and presentation files from a storage device.

Server outputs a collection of raw document objects that each contain a source identifier, a content type, and raw data bytes.

### Step 2:

Server converts raw document objects into normalized text segments.

Server uses a document parsing library to transform the raw data bytes of each document object into a plain text string as input.

Server applies text cleaning operations to the string, including removal of markup tags, control characters, headers, and footers, by executing pattern matching and substitution functions.

Server then segments the cleaned text into sentences and paragraphs by detecting punctuation symbols and line breaks and by using sentence boundary models from a natural language processing library.

Server outputs a list of text segments where each segment is associated with a document identifier and a segment identifier.

### Step 3:

Server extracts philosophy and culture information from the text segments.

Server uses a natural language processing model as input processor, taking each text segment and converting it into a feature vector using word embeddings or contextual token representations.

Server applies a classifier, implemented as a trained neural network, that receives the feature vector as input and outputs a category label such as “philosophy,” “culture,” or “other.”

Server filters segments labeled as “philosophy” or “culture,” groups them by label type, and stores them as organization profile records.

Server outputs a structured organization profile that includes categorized lists of philosophy paragraphs and culture paragraphs.

### Step 4:

Server generates embeddings for organization profile paragraphs and builds a vector index.

Server sends each philosophy or culture paragraph as input text to an embedding service that implements a neural network encoder.

Server receives, for each paragraph, a numeric vector as output, where the elements of the vector represent coordinates of the paragraph in a semantic space.

Server inserts each vector, together with metadata such as paragraph identifier and category, into a vector index data structure implementing approximate nearest neighbor search.

Server outputs an indexed organization profile in which each paragraph is associated with a stored embedding and can be efficiently retrieved based on similarity.

### Step 5:

Server constructs a base prompt sentence for configuring the generative AI model.

Server takes as input the categorized philosophy and culture paragraphs from the organization profile.

Server selects representative paragraphs according to predefined rules, such as taking top paragraphs by length or importance score, and concatenates them into a single text block.

Server prepends an instruction text that defines the role of the generative AI model, such as:

“You are a generative AI model that creates and evaluates interview questions for assessing how well a candidate aligns with the philosophy and culture of an organization.”

Server appends the concatenated organization philosophy text under a heading such as:
“Organization philosophy and culture:
‘[ . . . ]’”,

Server outputs a base prompt sentence that will be used as context input when calling the generative AI model.

### Step 6:

Server prepares interview conditions and generates initial interview questions.

Server receives interview conditions as input, including a job type, target role, and evaluation viewpoints such as “customer service” or “teamwork.”

Server encodes the evaluation viewpoints into an embedding vector and queries the vector index using this vector as input, retrieving the most similar organization profile paragraphs as output.

Server inserts the retrieved paragraphs and the interview conditions into a new prompt sentence that includes instructions such as:
“You are a generative AI model that creates interview questions.
Organization philosophy and culture:
‘[ . . . ]’
Based on this philosophy, generate 5 interview questions that assess a candidate's fit for the role of [job type].”

Server sends the prompt sentence to the generative AI model as input and receives a sequence of generated tokens representing multiple interview questions as output.

Server parses the generated text into individual question strings and outputs a structured question list.

### Step 7:

Server transmits interview questions to the terminal.

Server takes as input the structured question list and the identifier of the target terminal.

Server encodes the question list into a message format such as a structured text object and sends the message via a network interface to the terminal.

Server records a mapping between each question and an internal question identifier for later correlation with answers.

Server outputs a transmission log and maintains state indicating that the interview session is initialized.

### Step 8:

Terminal receives and stores interview questions.

Terminal accepts the transmitted message from the server as input through its communication module.

Terminal parses the message to extract the list of question strings and associated identifiers.

Terminal stores the questions and identifiers in local memory, in a data structure that maintains the current index of the question to be displayed.

Terminal outputs an updated internal state indicating that questions are ready for display.

### Step 9:

Terminal visually presents interview questions to the user.

Terminal takes as input the current question from the local question list and its associated identifier.

Terminal uses a graphics API to render the question text as an overlay in the display area of the smart glasses so that the question appears in the user's field of view.

Terminal may display control indicators such as “next” or “start answer” icons and waits for user interaction signals from touch sensors, buttons, or voice commands.

Terminal outputs the question visually and outputs an internal state indicating that the system is awaiting the user's answer.

### Step 10:

User reads the question and provides a verbal answer.

User observes the displayed text question through the terminal's display.

User interprets the question and generates a natural language spoken answer, speaking into the environment so that the terminal's microphone can capture the sound.

User optionally triggers recording start and stop through a voice command or a physical control on the terminal.

User outputs an acoustic signal that encodes the answer content as voice information.

### Step 11:

Terminal captures the user's voice information and forwards it for speech recognition.

Terminal uses an audio driver and microphone hardware to sample the analog acoustic signal as input and to convert it into digital audio frames at a defined sampling rate and bit depth.

Terminal buffers the audio frames and, depending on configuration, either streams the audio in real time or sends a recorded chunk to a speech recognition engine.

Terminal attaches metadata such as question identifier and time stamp to the audio data.

Terminal outputs a request containing the audio data and metadata to the speech recognition service or to the server.

### Step 12:

Server receives transcribed text for the user's answer.

Server either directly receives audio data from the terminal and forwards it to a speech recognition service, or receives already transcribed text from the terminal or recognition service as input.

If the server receives audio, the server sends the audio frames to a speech recognition engine that processes acoustic features and produces recognized text tokens as output.

Server associates the recognized text string with the corresponding question identifier and stores it as a raw answer record in a database.

Server outputs normalized text for the user's answer, including fields such as session identifier, question identifier, and answer text.

### Step 13:

Server normalizes and tokenizes the answer text.

Server takes as input the raw answer text string from the answer record.

Server applies text normalization operations, including lowercasing, removal of filler words, and standardization of punctuation, using predefined rules and text processing functions.

Server uses a tokenizer from a natural language processing library or from the generative AI model environment to split the normalized text into tokens according to the model's vocabulary.

Server outputs a token sequence representation of the answer and updates the answer record with the normalized text.

### Step 14:

Server constructs an evaluation prompt sentence for the generative AI model.

Server retrieves, as input, the question text, the normalized answer text, and relevant organization philosophy paragraphs from the organization profile.

Server concatenates these elements into a structured instruction text that includes sections such as “Organization philosophy and culture,” “Interview question,” and “Candidate's answer.”

Server adds explicit output requirements to the instruction, for example:

“Evaluate how well this answer aligns with the organization's philosophy. Output a structure with: score (1-5), strengths, concerns, and a 2-3 sentence summary.”

Server outputs a complete evaluation prompt sentence that will guide the generative AI model to generate structured evaluation data.

### Step 15:

Server calls the generative AI model to analyze the answer and generate evaluation information.

Server sends the evaluation prompt sentence and associated parameters, such as maximum token length and sampling settings, as input to the generative AI model.

Server receives as output a generated text sequence representing the evaluation, including a numerical score and explanatory comments, formatted according to the instruction.

Server parses the generated text to extract fields such as “score,” “strengths,” “concerns,” and “summary,” using pattern recognition or a lightweight parser.

Server outputs a structured evaluation record that links the evaluation fields to the corresponding answer and question identifiers.

### Step 16:

Server derives emotional state and attitude tendency from the answer.

Server takes as input the normalized answer text and, optionally, the embeddings or intermediate features generated during the evaluation prompt processing.

Server applies a specialized classifier model that analyzes the answer content and outputs quantitative scores for emotional dimensions (for example, confidence or empathy) and attitude traits (for example, customer orientation).

Server combines these scores with the structured evaluation record, populating additional fields such as “emotional_state_scores” and “attitude_scores.”

Server outputs an enriched evaluation record that includes both alignment information and behavioral indicators.

### Step 17:

Server generates a control prompt sentence for dynamic follow-up questioning.

Server reads the enriched evaluation record as input and applies rule-based logic or threshold comparisons to determine whether follow-up questions are needed.

Server constructs a new prompt sentence that includes key evaluation values and instructions, for example:
“Based on the following evaluation information:
alignment score: 2 out of 5,
empathy: low,
Generate 3 follow-up interview questions that explore why the candidate may not prioritize listening to customers.”

Server outputs this control prompt sentence as a new instruction for the generative AI model.

### Step 18:

Server generates additional interview questions based on the control prompt sentence.

Server sends the control prompt sentence to the generative AI model as input and receives as output a set of follow-up question texts that are conditioned on the evaluation results.

Server parses the generated text to separate individual questions and assigns new question identifiers linked to the previous answer and evaluation record.

Server stores the follow-up questions in the database as an extension of the interview session and prepares a message containing these questions.

Server outputs the updated question set and transmits the follow-up questions to the terminal.

### Step 19:

Terminal receives and presents follow-up questions.

Terminal takes as input the message from the server containing follow-up question texts and identifiers.

Terminal updates its local question list to include the newly received questions in a position after the current question or in a separate follow-up section.

Terminal uses the display unit to render the next follow-up question as overlaid text in the user's view, indicating that the question is a follow-up.

Terminal outputs a new visible question and updates its state to await the user's next verbal answer, thus continuing the interactive interview process.

### Step 20:

Server outputs final evaluation information to terminal and evaluator display device.

Server aggregates evaluation records across all questions in the session as input, computing overall indices such as average alignment score or weighted composite scores.

Server composes a summary text that describes the candidate's suitability, referencing key strengths and concerns derived from the generative AI model outputs and classifiers.

Server sends a concise summary and overall score to the terminal for presentation to the user, and sends a detailed report to an evaluator display device for human review.

Server outputs both summary and detailed evaluation information, completing the data processing flow for the interview session.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional interview support systems that utilize general-purpose natural language processing simply present predefined questions and store candidate answers as unstructured text. In such systems, processing resources of a computing device are mainly consumed for static text display and basic logging, while contextual understanding of an organization's guidelines and values, and dynamic adaptation of interview content to a candidate's emotional state, are not technically integrated into the core processing flow. As a result, the computing device treats all organizations and candidates in substantially the same manner, which leads to several technical problems.

First, a conventional system is not configured to construct and maintain a machine-readable concept structure that represents organization-specific guideline information and value information. Text data that describes an organization's culture is typically stored as raw documents and is not transformed into structured learning data suitable for a generative AI model. Consequently, the system cannot efficiently utilize its processing resources to generate organization-specific interview questions, and the generative AI model, if used at all, operates on generic prompts and yields generic outputs.

Second, conventional systems are not configured to automatically generate and manage prompt sentences that embed both organization-specific condition information and interview context information. Many systems rely on manually crafted prompts or static templates, which are not programmatically adapted based on candidate responses or emotional signals. This causes inefficiency in model invocation, as the generative AI model must repeatedly process incomplete or suboptimal instructions, thereby increasing computational load while producing low-relevance questions and analyses.

Third, candidate answers in conventional systems are often stored as plain text without being transformed into structured emotional state information or attitude tendency information. Such systems fail to exploit natural language processing modules to extract feature data, emotion indices, or compatibility indices that can be reused across different processes. This lack of structured representation prevents the computing device from efficiently reusing intermediate results, requires redundant parsing in downstream modules, and impedes low-latency generation of real-time feedback to the terminal device.

Fourth, conventional interview support systems are not technically configured to dynamically control the sequence, content, and expression of subsequent questions based on real-time emotional analysis. The computing device executes a predetermined script of questions independent of candidate state, so there is no feedback loop between analysis results and question generation. This absence of a closed control loop results in underutilization of the processor and memory resources of the system, prevents optimization of data flow between analysis modules and generative modules, and leads to delays or failures in adapting the dialogue to the candidate.

Accordingly, there is a need for a technical solution that enables a computing device to: (i) transform organization-specific text information into structured learning data and adapted generative models, (ii) automatically generate and manage prompt sentences containing organization-specific and candidate-specific condition information, (iii) convert unstructured candidate answers into structured emotional and compatibility indices, and (iv) use those indices to drive dynamic generation and delivery of real-time feedback and subsequent questions. Such a solution should improve the efficiency and functionality of the underlying computer system itself, by reducing redundant processing, enabling more effective use of generative AI model resources, and establishing a closed control loop between analysis and generation components in an interview support environment.

The specific processing by the specific processing unit 290 of the data processing device 12 in Example 2 is realized by the following means.

The present invention provides a server comprising a processor configured to acquire text information including guideline information and value information related to an organization, perform preprocessing and feature extraction on the text information, and generate learning data representing a concept structure specific to the organization; to execute a learning process or an adaptation process on a generative AI model implemented by a generative information processing apparatus, using the learning data as input, and construct a generative AI model that reflects the guideline information and the value information of the organization; to generate a prompt sentence to be input to the generative AI model, the prompt sentence including condition information based on the guideline information and the value information of the organization and including interview target information; to input the prompt sentence to the generative AI model, cause the generative AI model to generate dialogue output information including question text information for eliciting honest opinions and emotional reactions from a candidate, and transmit the dialogue output information to a terminal device; to acquire answer text information of the candidate transmitted from the terminal device, analyze the answer text information using natural language processing, extract emotional state information and attitude tendency information from the answer text information, and store the emotional state information and the attitude tendency information as structured data; to execute an emotion evaluation process and a compatibility estimation process on the structured data, and calculate a compatibility index with the guideline information and the value information of the organization and an emotional state index of the candidate; and to generate real-time feedback information to be provided during an interview and evaluation information for an administrator, based on the compatibility index and the emotional state index, and transmit the real-time feedback information to the terminal device. This enables the computing system to internally transform organization-specific and candidate-specific natural language data into structured representations that can be efficiently reused by generative and analytical modules, to automatically construct and apply optimized prompt sentences for the generative AI model, and to implement a closed feedback loop in which the processor dynamically controls question generation and feedback delivery based on real-time emotional indices, thereby improving the overall performance, responsiveness, and resource utilization of the interview support computer system.

The term “organization” refers to any entity, including but not limited to a business entity, public institution, or group, that maintains guideline information and value information related to its activities.

The term “guideline information” refers to information indicating principles, policies, missions, or behavioral standards that the organization expects its members or related persons to follow.

The term “value information” refers to information indicating beliefs, priorities, cultural characteristics, or evaluation criteria that the organization regards as important.

The term “text information” refers to information expressed in a natural language character string format, including sentences, paragraphs, and documents, which describe the guideline information and the value information of the organization.

The term “preprocessing” refers to a series of operations performed on text information, including normalization, tokenization, segmentation, noise removal, and similar operations, in order to prepare the text information for subsequent analysis or learning.

The term “feature extraction” refers to processing that converts text information into numerical or symbolic feature data, such as vectors, tokens, or tags, which can be used as input to a learning algorithm or a model.

The term “learning data” refers to data obtained from text information through preprocessing and feature extraction, and structured so as to be suitable for use in a learning process or an adaptation process of a model.

The term “concept structure” refers to a representation, such as a set of features, vectors, or relations, that expresses relationships among concepts included in the guideline information and the value information of the organization.

The term “generative information processing apparatus” refers to an information processing apparatus, including hardware and software resources, that executes a generative AI model to produce output data, such as text, in response to input data.

The term “generative AI model” refers to a machine learning model, including a probabilistic model or a neural network model, that generates natural language text or other data outputs based on input data and learned parameters.

The term “learning process” refers to processing in which parameter values of the generative AI model are updated using the learning data so that the generative AI model reflects characteristics of the learning data.

The term “adaptation process” refers to processing in which the generative AI model is adjusted or conditioned, without necessarily changing all internal parameters, based on the learning data or configuration information, so as to reflect the guideline information and the value information of the organization.

The term “prompt sentence” refers to an input text sequence provided to the generative AI model, including instructions, conditions, or context, which causes the generative AI model to generate an output corresponding to the instructions.

The term “condition information” refers to information included in the prompt sentence that restricts or specifies generation conditions of the generative AI model, such as topics, style, tone, or target attributes.

The term “interview target information” refers to information indicating attributes of a subject of an interview, including but not limited to candidate identifiers, roles, positions, or interview scenarios, and included in the prompt sentence.

The term “dialogue output information” refers to output information generated by the generative AI model based on the prompt sentence, including question text information or other natural language expressions for conducting a dialogue.

The term “question text information” refers to text information in a natural language form that is configured as an interrogative sentence or a prompt presented to a candidate in an interview.

The term “terminal device” refers to any information processing device, such as a mobile device, personal computer, or similar device, that receives dialogue output information from the server and transmits answer text information from a candidate to the server.

The term “answer text information” refers to text information expressed in a natural language that is input by a candidate as a response to the question text information and transmitted from the terminal device to the server.

The term “natural language processing” refers to computational processing applied to natural language text, including tokenization, parsing, classification, sentiment analysis, or similar operations.

The term “emotional state information” refers to information representing an emotional condition of a candidate, such as positivity, negativity, anxiety, or confidence, inferred from the answer text information.

The term “attitude tendency information” refers to information representing a candidate's stance, orientation, or inclination, such as agreement, skepticism, or neutrality, inferred from the answer text information.

The term “structured data” refers to data represented in a predefined format, such as records, tables, or key-value structures, that organizes the emotional state information and the attitude tendency information for subsequent processing.

The term “emotion evaluation process” refers to processing that analyzes the structured data to quantify or classify the emotional state of a candidate.

The term “compatibility estimation process” refers to processing that evaluates a relationship between the structured data and the guideline information and the value information of the organization to estimate a degree of compatibility.

The term “compatibility index” refers to a numerical or categorical measure indicating how well the candidate's responses or inferred attributes align with the guideline information and the value information of the organization.

The term “emotional state index” refers to a numerical or categorical measure derived from the emotional state information, indicating a level or category of the candidate's emotional condition.

The term “real-time feedback information” refers to information generated and provided during an ongoing interview session, based on the compatibility index and the emotional state index, to influence or adjust the interview flow or guidance displayed on the terminal device.

The term “evaluation information for an administrator” refers to information summarized or structured for use by a managing person, including indices, analysis results, or summaries, that support assessment of the candidate.

The term “question content that is difficult to present in direct human dialogue” refers to question content that is typically avoided or restricted in face-to-face interviews due to social, psychological, or regulatory considerations, but can be presented via an automated interview system.

The term “question formats that induce honest responses” refers to question structures or phrasings that encourage a candidate to provide more candid or detailed answers, such as open-ended or reflective questions.

The term “internal intentions” refers to implicit goals, motivations, or desires of the candidate that may not be explicitly stated but can be inferred from the candidate's responses.

The term “latent concerns” refers to potential doubts, anxieties, or reservations of the candidate that are not directly stated but can be inferred from patterns or nuances in the candidate's responses.

The term “control conditions” refers to parameters or rules included in a prompt sentence that specify how subsequent questions are to be selected, ordered, or phrased in an interview.

The term “interview progress” refers to a state or stage of an interview process, including which questions have been presented, which remain, and how interaction with the candidate is advancing.

The term “question sequence” refers to an ordered series of questions to be presented to the candidate during an interview.

The term “dynamic change” refers to modification of the interview progress or question sequence during runtime in response to newly obtained emotional state information or attitude tendency information.

In one embodiment, a server implements the claimed system using one or more general-purpose processors, a memory subsystem, a network interface, and a non-transitory storage medium. The server executes application software implemented, for example, in a high-level programming language such as Python or Java, running on an operating system such as a server-grade operating system. The server accesses a database system, such as a relational database or a document-oriented database, and a model execution framework, such as a neural network framework executing on a graphics processing unit (GPU) or tensor processing unit (TPU). The server further communicates with one or more terminal devices operated by users via a network such as the Internet.

The server uses a generative AI model implemented as a neural network of the transformer type. The server, for example, uses a model architecture including multiple self-attention layers, feed-forward layers, layer normalization, and positional encoding. Each self-attention layer computes attention scores between token representations using a scaled dot-product operation, and each feed-forward layer applies a non-linear transformation, such as a rectified linear unit activation, to improve representational capacity. The server stores model parameters, including weight matrices and bias vectors, as numerical arrays in the memory and updates or adapts these parameters using a training procedure, such as stochastic gradient descent with an adaptive optimizer, according to an error function that measures the difference between predicted token probabilities and target tokens.

The server acquires text information representing guideline information and value information of an organization from storage. The server may retrieve raw text documents from a document store, a database, or a file system, including mission statements, internal policy documents, culture descriptions, and interview guidelines. The server normalizes these documents into a unified text format, such as UTF-8 encoded plain text, and stores them as entries in a corpus table. The server then executes a preprocessing pipeline, implemented for example using a natural language processing library such as spaCy or a similar tool, to perform tokenization, sentence segmentation, lowercasing, removal of non-textual symbols, and optional lemmatization.

The server converts the preprocessed text into learning data suitable for input to the generative AI model. The server maps each token to an integer index using a vocabulary mapping, and then converts the token indices into dense vector representations using an embedding matrix. The server may further construct additional feature vectors, such as segment identifiers, positional indices, or mask vectors indicating which tokens belong to which document segments. The server combines these vectors into a structured data format, such as a tensor of shape [batch_size, sequence_length, embedding_dimension], that forms the learning data. The server stores metadata, such as document identifiers and organization identifiers, in accompanying index tables.

The server applies a learning process or an adaptation process to the generative AI model using the learning data. In one embodiment, the server fine-tunes a pre-trained transformer model by performing supervised learning on sequences of organization-specific text. The server defines a loss function, such as cross-entropy between the predicted token distribution and the next-token target in each sequence. The server computes gradients of the loss with respect to model parameters via backpropagation, and updates the parameters using an optimization algorithm, such as Adam or a similar adaptive gradient method, with learning rate scheduling. The server may apply regularization techniques, such as dropout in attention layers and weight decay, to prevent overfitting to the organization data.

The server thereby constructs an adapted generative AI model that contains internal parameter values tuned to the guideline information and the value information of the particular organization. The server stores the adapted model in model storage, such as a binary file or a model registry, together with version identifiers and associated organization identifiers. This configuration allows the server to select and load an appropriate model instance for each organization, thereby avoiding repeated training and reducing unnecessary computational load.

The server generates a prompt sentence that serves as input to the adapted generative AI model. The server composes the prompt sentence by combining fixed instruction segments with dynamic condition information. For example, the server may include textual segments that describe the purpose of question generation, the desired style (such as open-ended and non-leading), and the organization's core values. The server retrieves organization-specific phrases, such as core values or culture descriptors, from the database and inserts them into placeholders of a prompt template. The server may also append interview target information, such as a job role, seniority level, or interview phase, to the prompt sentence.

For example, the server may generate a prompt sentence such as: “Using the organization's philosophy and unique culture that you have learned, generate 8 open-ended interview questions that will draw out the candidate's honest opinions about our organization. Focus on benefits they expect from working here, aspects of our culture they resonate with, and areas where they feel doubts or concerns. Avoid yes/no questions, and phrase each question in clear, natural language.”

The server provides the prompt sentence to the generative AI model as a sequence of token indices and corresponding embeddings. The server performs inference by propagating the input through the transformer layers of the model, computing attention weights and intermediate hidden states for each token position. The server then applies a decoding algorithm, such as greedy decoding or beam search, to select output tokens with high predicted probability. The server accumulates generated tokens until an end-of-sequence condition is met, such as encountering a special end token or reaching a maximum length. The server converts the output token indices back into a natural language string that constitutes dialogue output information, including question text information.

The server may post-process the generated question text information by splitting the string into separate questions based on punctuation or delimiter tokens and by applying basic syntactic checks. The server stores each question as a record containing question text, question identifier, model version, organization identifier, and metadata, such as a tag indicating that the question is designed to elicit honest opinions or emotional reactions. The terminal receives the dialogue output information from the server via a network communication protocol, such as HTTPS. The terminal may be implemented as a smartphone, a tablet, or a personal computer executing a web browser or a native application. The terminal decodes the received data, such as a structured response including question identifiers and question texts, and displays the questions on a graphical user interface. The terminal may use layout components, such as text labels and multi-line input fields, to present each question and accept answer text information from a user.

The user views the questions on the terminal and inputs answer text information using an input interface, such as a touch keyboard, a hardware keyboard, or a speech-to-text engine. The user may edit and confirm the answers and then submit them. The terminal groups the answers with corresponding question identifiers and transmits the answer text information to the server using a secure network connection.

The server receives the answer text information and performs natural language processing to extract emotional state information and attitude tendency information. The server applies tokenization and, optionally, part-of-speech tagging and dependency parsing to identify key linguistic structures. The server may use a secondary neural network for emotion classification, such as a transformer-based classifier or a recurrent neural network, trained on labeled emotional text data. The server converts each answer into an embedding representation using an encoder and feeds the embeddings into a classification layer that outputs a probability distribution over predefined emotional categories, such as positive, neutral, negative, anxiety, or confidence. The server defines a classification loss function, such as cross-entropy, during training, and learns classifier parameters accordingly.

The server determines emotional state information by selecting the most probable emotional category and, optionally, storing the full probability vector as a more detailed emotional profile. The server also computes attitude tendency information by applying additional classifiers or rule-based modules that detect patterns of agreement, skepticism, or neutrality relative to the organization's guidelines and values. For example, the server may compare semantic similarity between candidate responses and representative phrases of the organization's value information using vector similarity measures, such as cosine similarity, and interpret high similarity as agreement and low similarity as dissonance.

The server stores emotional state information and attitude tendency information as structured data in a database. The server associates each record with a candidate identifier, question identifier, and timestamp. The server may employ normalized table schemas or key-value structures to allow efficient retrieval and aggregation of these data. By storing structured data, the server avoids repeated parsing of raw text and enables downstream modules to operate directly on compact feature vectors and indices.

The server executes an emotion evaluation process and a compatibility estimation process on the structured data. The server aggregates emotional state information across multiple answers to compute an emotional state index, such as a weighted sum or average of emotional scores, and normalizes the index to a predetermined range. The server computes a compatibility index by comparing the extracted attitude tendency information and semantic features of the candidate's answers with stored representations of the organization's guideline information and value information. The server may use vector-based similarity metrics, clustering algorithms, or logistic regression models to map the feature data to a scalar index that indicates alignment with the organization. The server stores these indices as numerical values and uses them as triggers or control values for subsequent processing.

The server generates real-time feedback information based on the emotional state index and the compatibility index. The server composes feedback messages that instruct the terminal how to adjust the interview, such as suggesting that more exploratory questions be asked in areas where the candidate shows uncertainty, or that the interview proceed to a next topic when strong alignment has been detected. The server may, for example, generate a new prompt sentence for the generative AI model that explicitly conditions on the candidate's current emotional state and known areas of interest or concern. An example of such a prompt sentence is:

“Here are the candidate's emotional state and attitude tendencies inferred from previous answers: the candidate shows high interest in collaborative work, moderate concern about workload, and some skepticism regarding management transparency. Generate 5 follow-up interview questions that explore these concerns in a respectful, open-ended manner, avoiding yes/no questions and encouraging the candidate to elaborate freely.”

The server inputs this prompt sentence to the generative AI model, generating follow-up questions that are adapted to the candidate's state. The server transmits the resulting dialogue output information to the terminal, thereby creating a closed control loop between analysis and generation. Because the server uses internal indices rather than raw text for this control, the server can make prompt construction decisions quickly, reducing latency in real-time interactions.

The server thereby improves computer technology in several respects. First, the server transforms raw natural language documents into structured learning data and adapted model parameters, which reduce redundancy and allow the generative AI model to produce organization-specific outputs more efficiently than generic models. Second, the server automatically constructs prompt sentences using stored guideline information, value information, and dynamic emotional indices, which reduces the need for manual prompt engineering and enables consistent, high-quality control of model behavior. Third, the server stores emotional state information and attitude tendency information as reusable structured data, enabling subsequent algorithms to operate on compact feature representations, decreasing processing time and memory usage when compared to repeatedly analyzing unstructured text. Fourth, the server's feedback loop control, which uses compatibility indices and emotional state indices as inputs to prompt generation, allows the interview sequence to be dynamically adapted while reducing the amount of data exchanged between the server and the model by providing only necessary contextual features instead of raw transcript data.

The terminal contributes to technical improvement by presenting structured questions and feedback with low rendering overhead and by aggregating answer text information in association with question identifiers before transmission, which reduces network communication volume. The terminal can cache interface templates and only update textual content, thereby minimizing re-rendering operations and reducing power consumption on mobile devices. The terminal also ensures that answer text is transmitted in a structured format, such as a collection of key-value pairs with fixed schema, allowing the server to parse and process the data with reduced overhead.

The user interacts with the system by inputting answers that the server converts into structured indices using non-conventional processing sequences. Unlike manual interviews where an interviewer reads and interprets responses, the server applies non-human strategies, including high-dimensional embedding computation, vector-based similarity calculation, probabilistic classification, and gradient-based parameter adaptation. These strategies operate at speeds and scales that cannot be achieved by human operators and enable systematic, repeatable extraction of emotional and compatibility profiles across large candidate populations.

In another embodiment, the server uses alternative model architectures, such as recurrent neural networks with long short-term memory units or gated recurrent units, for the emotion classification component while still using a transformer-based generative model for question generation. The server may also use different optimization algorithms, such as stochastic gradient descent with momentum or RMSProp, depending on the computational environment. These variations still preserve the essential structure where organization-specific learning data, prompt sentence construction, structured emotional indices, and feedback loops are combined to improve computer-based interview support.

In yet another embodiment, the server partitions functionality across multiple physical nodes. One node performs preprocessing and feature extraction, another node performs model training and adaptation on specialized hardware such as GPUs, and a third node handles real-time inference and interaction with terminal devices. This partitioning allows the system to scale to large numbers of concurrent interviews while maintaining low response times. Because the structured data and indices are compact, the server can transmit them between nodes with reduced bandwidth compared to raw text, thereby reducing network load within the system.

By combining detailed data structures for learning data, explicit algorithms for emotional and compatibility index computation, and controlled prompt sentence generation feeding into a generative AI model, the server implements a concrete technical solution that enhances processing speed, accuracy, and resource utilization of the underlying computer system, beyond mere automation of human interview tasks.

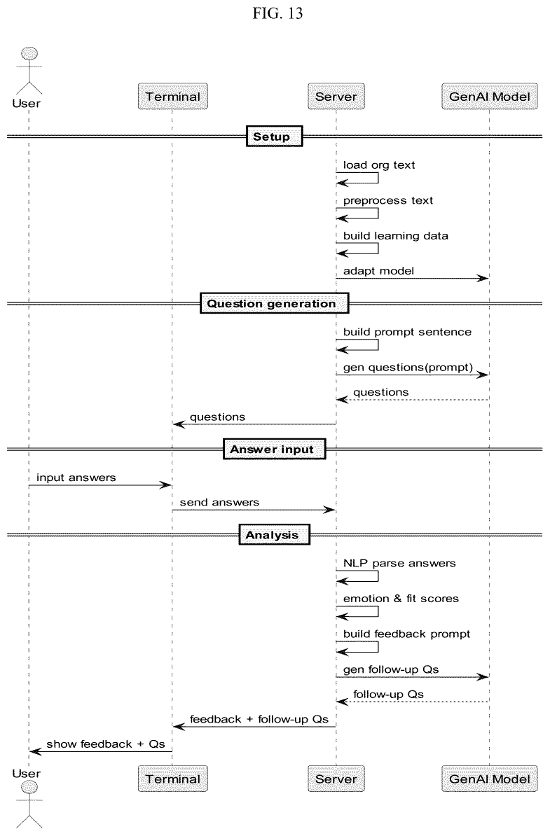

The following describes the processing flow using FIG. 13.

### Step 1:

Server acquires organization text information.

Server receives as input multiple text documents containing guideline information and value information of an organization from a storage apparatus or an administrator terminal. Server reads raw text files, database records, or document objects, normalizes character encoding to a unified format (for example, UTF-8), and concatenates or indexes the documents into a corpus structure. As output, server produces a corpus dataset in which each document is associated with a document identifier and organization identifier.

### Step 2:

Server preprocesses the corpus dataset.

Server takes as input the corpus dataset from Step 1 and executes a natural language preprocessing pipeline using a language processing library. Server performs sentence segmentation, tokenization, lowercasing, removal of non-linguistic symbols, and optional lemmatization. Server then converts the cleaned tokens into an intermediate representation, such as a list of token sequences for each document. As output, server generates preprocessed text data that is stored in a structured form, for example as records linking document identifiers to token sequences.

### Step 3:

Server generates learning data and feature structures.

Server receives as input the preprocessed text data from Step 2 and a vocabulary mapping that assigns indices to tokens. Server converts each token into an integer index and then into an embedding vector using an embedding matrix stored in memory. Server constructs tensors representing sequences of embeddings and associated positional indices and segment identifiers. Server aggregates these tensors into batches for efficient processing. As output, server produces learning data in the form of batched tensors and auxiliary metadata tables that map batches to original documents and organizations.

### Step 4:

Server adapts the generative AI model using the learning data.

Server takes as input the learning data from Step 3 and an initial set of model parameters of a transformer-based generative AI model. Server performs a learning process in which server feeds batched tensors into the model, computes output token probability distributions, and evaluates a loss function, such as cross-entropy between predicted tokens and target tokens. Server computes gradients by backpropagation and updates model weights using an optimization algorithm. Server repeats these operations for multiple epochs until a convergence criterion is satisfied. As output, server produces an adapted generative AI model whose internal parameters encode organization-specific guideline information and value information.

### Step 5:

Server constructs a base prompt template.

Server receives as input organization metadata, such as key value phrases, mission statements, and culture descriptors, from a database, and possibly generic instruction patterns stored as templates. Server integrates this information by inserting organization-specific phrases into placeholder positions within a generic template. Server may, for instance, embed text that specifies the purpose of the interview, the desired question style, and the target type of candidate. As output, server generates a base prompt template text that is partially parameterized and ready to be specialized for individual interview sessions.

### Step 6:

Server generates a concrete prompt sentence for initial question generation.

Server takes as input the base prompt template from Step 5 and interview target information, such as candidate role, department, and interview stage. Server fills the remaining placeholders in the template with these parameters and concatenates the segments into a single natural language instruction. Server may validate that the length of the prompt is within model constraints and that required condition information, such as focus topics and constraints on question form, is included. As output, server produces a concrete prompt sentence, for example:

“Using the organization's philosophy and unique culture that you have learned, generate 8 open-ended interview questions that will draw out the candidate's honest opinions about our organization. Focus on benefits they expect from working here, aspects of our culture they resonate with, and areas where they feel doubts or concerns. Avoid yes/no questions, and phrase each question in clear, natural language.”

### Step 7:

Server generates initial interview questions using the generative AI model.

Server receives as input the concrete prompt sentence from Step 6 and the adapted generative AI model from Step 4. Server encodes the prompt sentence into token indices and passes them through the model to compute hidden states via attention and feed-forward layers. Server applies a decoding algorithm, such as beam search with a predefined beam width, to iteratively select output tokens according to predicted probabilities. Server stops the decoding when an end-of-sequence token is generated or a maximum length is reached. As output, server produces generated question text information, typically as a long string containing multiple questions.

### Step 8:

Server post-processes generated questions and stores them.

Server takes as input the generated question text information from Step 7 and splits the text into individual questions using punctuation marks, newline characters, or special separators. Server removes duplicates or incomplete sentences, trims whitespace, and optionally checks basic grammatical correctness using a language checker. Server assigns a unique question identifier and associates each question with the organization identifier, model version, and generation time. As output, server stores a set of cleaned question records in a question table in a database.

### Step 9:

Server selects a question set for a candidate session.

Server receives as input candidate session information, such as candidate identifier, job role, language preference, and interview configuration parameters, as well as available question records from Step 8. Server filters questions by organization and language, and may apply selection rules, such as diversity of topics, difficulty balancing, and avoidance of previously used questions for the same candidate. Server sorts or groups the selected questions into an ordered list corresponding to an initial interview plan. As output, server generates a session-specific question set and encapsulates it in a response structure containing question identifiers and question texts.

### Step 10:

Terminal requests and displays interview questions.

Terminal receives as input session initialization commands from a user or from an administrator and sends a request to the server asking for questions for a specified session. Terminal obtains as output the session-specific question set from Step 9 via network communication. Terminal parses the response structure and instantiates user interface elements, such as text labels and input fields, on a display. Terminal renders each question text and prepares an associated text input area for the user. As output, terminal provides a visual interface where questions from the server are shown to the user and ready for interaction.

### Step 11:

User reads questions and inputs answers.

User receives as input the displayed question texts from the terminal in Step 10. User cognitively interprets each question and generates an answer. User enters answer text into the terminal's input fields by operating a keyboard, touchscreen, or voice-to-text mechanism. User may revise answers before confirming. As output, user produces answer text strings, each associated with a particular question display, and causes the terminal to hold these answers in memory.

### Step 12:

Terminal packages and transmits answer text information.

Terminal takes as input the answer texts and corresponding question identifiers created in Step 11, along with session identifiers and timestamps. Terminal validates the inputs (for example, checks that mandatory answers are non-empty and that text lengths do not exceed limits) and structures them into a predefined data format, such as an array of records each containing a question identifier and answer text. Terminal then sends this structured data to the server via a secure network protocol. As output, terminal provides the server with a compact, structured answer payload.

### Step 13:

Server performs natural language processing on answers.

Server receives as input the structured answer payload from Step 12. Server applies tokenization and, if configured, part-of-speech tagging and syntactic parsing to each answer text. Server converts tokens into embedding vectors using an encoder, such as a transformer encoder or a recurrent neural network encoder. Server then passes the resulting embedding representations into one or more classification layers or regression layers that implement emotion and attitude prediction. Server computes output values, such as probability distributions over emotion categories and scalar scores for agreement or skepticism. As output, server generates emotional state information and attitude tendency information for each answer.

### Step 14:

Server converts emotional and attitude information into structured data.

Server takes as input the emotional state information and attitude tendency information from Step 13 and the associated session and question identifiers. Server maps categorical outputs, such as emotion labels, into numerical codes and stores probability vectors or scores as numerical arrays. Server writes these values into structured records in a database table, associating each record with a candidate identifier, question identifier, and timestamp. As output, server produces a structured dataset consisting of emotional profiles and attitude profiles that can be efficiently queried and aggregated.

### Step 15:

Server computes emotional state index and compatibility index.

Server receives as input the structured emotional and attitude data from Step 14 and stored representations of the organization's guideline information and value information (for example, embedding vectors derived from organization documents). Server aggregates per-answer emotional scores across questions to compute session-level emotional metrics, such as average positivity or variance of anxiety. Server also computes similarity measures between candidate response embeddings and organization value embeddings using vector operations, such as cosine similarity, and combines these measures into a scalar compatibility index using a predetermined function or a trained regression model. As output, server produces an emotional state index and a compatibility index for the candidate session.

### Step 16:

Server generates real-time feedback information.

Server takes as input the emotional state index and the compatibility index from Step 15 and applies decision rules or threshold conditions to determine how the interview should proceed. For example, server may detect that the emotional state index indicates rising anxiety and that compatibility with a certain value is low. Server composes natural language feedback messages or control messages indicating that supportive or clarifying questions should be presented. Server may also generate a new prompt sentence for the generative AI model that encodes these indices, such as:

“Here are the candidate's emotional state and attitude tendencies inferred from previous answers: the candidate shows high interest in collaborative work, moderate concern about workload, and some skepticism regarding management transparency. Generate 5 follow-up interview questions that explore these concerns in a respectful, open-ended manner, avoiding yes/no questions and encouraging the candidate to elaborate freely.”

As output, server provides feedback information and, optionally, an updated prompt sentence ready for further question generation.

### Step 17:

Server generates adaptive follow-up questions and sends them to the terminal.

Server receives as input the updated prompt sentence from Step 16 and the adapted generative AI model. Server repeats the encoding and decoding operations described in Step 7 to generate follow-up question text information aligned with the candidate's current emotional state and attitude profile. Server post-processes the generated text, assigns new question identifiers, and updates the candidate's session record. Server then encapsulates the new questions in a response structure and transmits them to the terminal. As output, server supplies an updated question set tailored to the candidate's emotional and compatibility indices.

### Step 18:

Terminal updates the user interface with feedback and new questions.

Terminal takes as input the real-time feedback information and adaptive question set from Step 17. Terminal refreshes or augments the displayed interface to present new questions and, if appropriate, to show guidance or feedback messages. Terminal may highlight follow-up questions as such, reorder visible elements, or hide questions that are no longer relevant. As output, terminal provides the user with an updated interview interface that reflects the dynamic adjustments made by the server, enabling continued interaction under the control of computed indices and generated prompt sentences.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional computer-implemented dialogue and interview systems, a computing apparatus typically presents static questions that are authored in advance and does not adapt the questioning strategy or explanatory content based on fine-grained analysis of a user's natural-language responses and emotional state. As a result, such systems have several technical limitations.

First, a computing apparatus generally treats organizational policy data, dialogue content, and emotion-related signals as independent data streams. The apparatus does not maintain a unified, machine-interpretable representation that links organizational policy and behavioral norms with user responses and emotional reactions. This separation limits the ability of the apparatus to automatically generate context-appropriate prompts for a generative AI model, and causes inefficient use of processing resources because the same organizational information must be repeatedly and manually curated for each interaction scenario.

Second, known systems that utilize generative AI models usually rely on fixed or manually defined prompt sentences. The computing apparatus does not dynamically reconfigure prompt sentences in response to computed features of a current session, such as extracted topics, sentiment values, or temporal changes in the user's emotional state. Consequently, the generative AI model tends to produce generic outputs that are weakly tailored to the current dialogue context, resulting in low quality question generation and explanations. From a computer-technical perspective, this leads to suboptimal use of the generative model's capacity and increased computational overhead, because additional post-processing or repeated interactions are required to obtain useful content.

Third, typical systems perform natural-language analysis and emotion recognition only as passive logging functions. The computed analysis results are stored but are not fed back into the dialogue generation loop in real time. The computing apparatus therefore cannot adjust question content, explanation granularity, or presentation order while a session is in progress. This lack of closed-loop control between analysis modules and a generative AI model prevents the apparatus from efficiently converging to an information state where the user's true intentions and concerns are exposed. Technically, the system operates in an open-loop manner with respect to user state, which degrades responsiveness and increases network and processing load due to unnecessary or irrelevant interactions.

Fourth, even when emotion recognition components are employed, they are typically limited to coarse-grained classification and are not systematically associated with specific generated sentences, prompts, and responses in a structured storage device. As a result, the computing apparatus cannot learn, over time, which prompt patterns or question styles are most effective at eliciting detailed, honest responses under particular emotional contexts. This hinders the capability of the apparatus to self-optimize its prompt generation strategy and to improve the performance of the overall dialogue subsystem across sessions.

Accordingly, there is a need for improved computer-implemented techniques that (i) tightly integrate organizational policy and behavioral-norm data, (ii) use this data to generate prompt sentences for a generative AI model, (iii) dynamically adapt those prompt sentences based on real-time natural-language and emotion analysis of user responses, and (iv) record the resulting interactions in a structured manner so that the system can update its generation policies. Such techniques should transform how the processor coordinates data acquisition, model prompting, dialogue generation, and feedback, thereby improving the efficiency, responsiveness, and effectiveness of the computing apparatus itself, rather than merely automating a human interview process.

The specific processing by the specific processing unit 290 of the data processing device 12 in Application Example 2 is realized by the following means.

The present invention provides a server comprising a processor configured to generate a prompt sentence for causing a generative AI model to learn organizational policy and behavioral norms based on text information stored in a storage device, to supply the prompt sentence and the text information to the generative AI model so that the generative AI model produces learned representation data of the organizational policy and behavioral norms, to generate a further prompt sentence for causing the generative AI model to generate an inquiry sentence or an explanation sentence for eliciting candid opinions and impressions from a dialogue target based on the learned representation data, to cause the generative AI model to output the inquiry sentence or the explanation sentence in response to the further prompt sentence, to transmit the inquiry sentence or the explanation sentence to a terminal apparatus, to receive from the terminal apparatus audio information, image information, or character information representing responses of the dialogue target, to execute speech recognition processing and natural language processing on the received information to obtain analysis data representing response content, to execute emotion specifying processing on the received information to estimate an emotional state of the dialogue target, to dynamically generate another prompt sentence to be provided to the generative AI model on the basis of the analysis data and the emotional state so that the generative AI model outputs a follow-up inquiry, a supplementary explanation, or a response policy adapted to the analysis data and the emotional state, to transmit the response policy to the terminal apparatus as real-time feedback during an ongoing dialogue, and to store, in the storage device, the response content, the emotional state, and the inquiry sentence, the explanation sentence, and the response policy generated by the generative AI model in association with one another, and to update, based on stored associations, a generation policy used by the processor when generating subsequent prompt sentences or inquiry sentences. This enables the computing system to implement a closed-loop control architecture in which organizational knowledge, generative AI prompting, real-time natural-language and emotion analysis, and structured logging are integrated such that the processor adaptively adjusts questions, explanations, and feedback in response to user state, thereby improving the technical performance of dialogue processing, reducing redundant interactions, and increasing the effectiveness and efficiency of information extraction by the generative AI model.

The term “processor” refers to a hardware or virtual computing element, such as a central processing unit, graphics processing unit, or programmable logic circuitry, configured to execute instructions to perform data processing operations described in the present specification.

The term “generative AI model” refers to an information processing model implemented by software and/or hardware that, given an input including at least one prompt sentence, generates new data such as natural-language text by probabilistic prediction or similar generative techniques learned from training data.

The term “prompt sentence” refers to a sequence of symbols including at least natural-language text that is supplied as input to a generative AI model in order to specify or constrain a generation task to be performed by the generative AI model.

The term “organizational policy” refers to information expressing fundamental principles, goals, and rules that guide activities of an organization, including but not limited to mission statements, value statements, and behavioral guidelines.

The term “behavioral norms” refers to information describing expected or typical patterns of behavior within an organization, including rules, customs, and practices that indicate how members of the organization are to act in various situations.

The term “text information” refers to information represented as a sequence of characters or tokens including letters, numerals, or symbols that can be processed by natural language processing or similar text-based processing.

The term “learned representation data” refers to data structures, model parameters, or intermediate encodings produced by a generative AI model or associated processing when the model has been adapted or conditioned to reflect organizational policy and behavioral norms.

The term “inquiry sentence” refers to one or more sentences generated by a generative AI model that include an interrogative expression intended to solicit a response from a dialogue target.

The term “explanation sentence” refers to one or more sentences generated by a generative AI model that present descriptive information intended to explain organizational policy, behavioral norms, or related topics to a dialogue target.

The term “dialogue target” refers to a human or other entity that provides responses to inquiry sentences or receives explanation sentences via a terminal apparatus in an interaction session with the system.

The term “terminal apparatus” refers to an end-user device including at least an input component and an output component, such as a portable information processing device, a desktop information processing device, or a wearable information presentation device, configured to communicate with the server.

The term “audio information” refers to information representing sound signals obtained from a dialogue target, including at least spoken utterances captured by a sensor such as a microphone and represented in digital form.

The term “image information” refers to information representing visual signals obtained from a dialogue target, including at least images or video frames captured by a sensor such as a camera and represented in digital form.

The term “character information” refers to information representing textual symbols, including letters, numerals, and punctuation, that express content of a response or input from a dialogue target.

The term “speech recognition processing” refers to processing that converts audio information containing spoken utterances into character information representing a transcription of the utterances.

The term “natural language processing” refers to processing that analyzes or transforms text information, including at least tokenization, syntactic analysis, semantic analysis, or information extraction applied to character information.

The term “analysis data” refers to data produced by speech recognition processing and natural language processing that represents extracted features of a response content, such as topics, sentiment values, or key phrases.

The term “emotion specifying processing” refers to processing that estimates an emotional state of a dialogue target on the basis of one or more of audio information, image information, or character information, using techniques such as pattern recognition or machine learning.

The term “emotional state” refers to information indicating one or more categories or intensities of affective conditions of a dialogue target, such as joy, interest, confusion, anxiety, or neutrality, estimated by emotion specifying processing.

The term “follow-up inquiry” refers to an inquiry sentence generated after an initial response, where the inquiry sentence is conditioned on at least one of analysis data and emotional state in order to further explore a topic.

The term “supplementary explanation” refers to an explanation sentence that is generated in addition to a prior explanation sentence and is conditioned on at least one of analysis data and emotional state to clarify or expand the prior explanation.

The term “response policy” refers to information indicating guidance, recommended actions, or system-generated feedback to be presented to a dialogue target or an operator, generated by a generative AI model based on a prompt sentence and at least one of analysis data and emotional state.

The term “real-time feedback” refers to a response policy or other information that is generated and transmitted by the server during an ongoing dialogue session within a time interval short enough for the dialogue target to perceive the information as contemporaneous with recent responses.

The term “storage device” refers to a hardware component or combination of components, such as a memory device or a non-volatile storage medium, configured to store information including response content, emotional state, and generated sentences in a retrievable manner.

The term “response content” refers to information representing the substantive meaning of a dialogue target's reply to an inquiry sentence, as obtained or derived from audio information, image information, or character information.

The term “generation policy” refers to parameters, rules, or metadata used by the processor when constructing a prompt sentence or determining how to request generation from a generative AI model, including selection of constraints, examples, or formatting instructions.

The term “managed person” refers to a dialogue target whose responses, behavioral characteristics, or emotional state are to be observed or evaluated by an operator through use of the system.

The term “constraint conditions” refers to one or more explicit requirements included in a prompt sentence that restrict characteristics of content to be generated by a generative AI model, such as the number of inquiries, an abstraction level, or targeted behavioral characteristics.

The term “abstraction level” refers to a degree of generality or specificity of generated content, including whether an inquiry is formulated in broad conceptual terms or in concrete, detailed terms.

The term “behavioral characteristics” refers to attributes describing tendencies of actions or reactions of a managed person or dialogue target, such as cooperation, initiative, or preference for certain working styles.

The term “explanation items” refers to individual topics or sections of content to be presented to a dialogue target, such as particular organizational policies or elements of behavioral norms.

The term “presentation order” refers to a sequence in which inquiry sentences, explanation sentences, or explanation items are output from the server to the terminal apparatus during an interview or dialogue.

In one embodiment, a server, a terminal, and a user cooperate to implement the claimed system. The server includes at least one processor, a main memory, a non-volatile storage device, and a network interface. The terminal includes at least one processor, a display, an input device, a microphone, a camera, and, in some cases, a speaker or head-mounted display. The user operates the terminal to participate in a dialogue or interview session.

The server functions as a dialogue control apparatus that coordinates acquisition of organizational policy data, configuration and prompting of a generative AI model, analysis of user responses, estimation of emotional states, dynamic generation of new prompt sentences, and feedback output. The terminal functions as an input/output apparatus that presents inquiry sentences and explanation sentences, acquires user responses in audio, image, and text form, and transmits the responses to the server.

### 1. Hardware and Software Configuration

The server uses general-purpose computing hardware, such as an x86-based or ARM-based processor with multiple cores, a main memory (for example, DRAM), and a non-volatile storage device (for example, a solid-state drive). The server executes an operating system such as a UNIX-compatible operating system and a runtime environment such as a Python runtime. The server executes several software modules, including:
a natural language processing library (for example, spaCy or an equivalent transformer-based pipeline) for tokenization, part-of-speech tagging, dependency parsing, and named-entity recognition,
a speech recognition client for calling a speech-to-text service (for example, a cloud speech recognition API),
an emotion specifying module that cooperates with an emotion analysis service (for example, a tone analysis API for text and a facial expression analysis SDK),
a generative AI model client that communicates with an external generative AI model via a network API, and
a database management system (for example, a relational database) for storing text information, learned representation data, response content, emotional states, and prompt sentences.

The terminal uses commercially available hardware such as a portable information processing device, a desktop information processing device, or a wearable information presentation device. The terminal executes an operating system and a client application. The client application comprises:
a user interface component that displays inquiry sentences and explanation sentences on the display,
an audio acquisition component that receives voice responses from the user through the microphone,
an image acquisition component that receives facial images or video frames of the user through the camera,
an optional text input component that receives typed responses from the user, and
a communication component that exchanges data with the server via a network using a secure communication protocol.

### 2. Organizational Policy Learning by a Generative AI Model

The server stores organizational policy and behavioral norms as text information in the storage device. The text information is obtained from digital documents, such as organizational guidelines, internal manuals, and human-resources policy documents. The server normalizes that text information by executing tokenization, sentence boundary detection, and removal of markup, so that the text information can be directly provided as input to a generative AI model.

The server uses a generative AI model implemented as a neural network architecture, such as a transformer-based language model. The generative AI model includes multiple layers of self-attention units and feed-forward networks, with learnable parameters (weights and biases) that have been pre-trained on a large corpus of natural-language text using an unsupervised objective such as next-token prediction or masked-token prediction. The server accesses the generative AI model through an application programming interface.

The server generates a first prompt sentence to cause the generative AI model to learn the organizational policy and behavioral norms. For example, the server generates the following prompt sentence:

“Summarize the following organizational policy and behavioral norms, and list key values and expected behaviors in bullet points.”

The server concatenates the prompt sentence with the normalized text information and supplies the concatenated text as input tokens to the generative AI model. The generative AI model performs forward propagation: the input tokens are embedded into vectors, processed through attention heads and feed-forward layers, and converted into output token probabilities. The model generates an output sequence that contains structured text such as bullet-point values, typical behaviors, and example narratives. The server stores this generated output as learned representation data linked to the original text information. Because the server uses the same generative AI model for multiple organizations and multiple interaction scenarios, the server caches the learned representation data in a structured data structure. For example, the server stores a record including:
an organization identifier,
a set of key value descriptors,
a set of behavior pattern descriptors, and
representative example texts.

This organization-specific learned representation data enables the processor to reuse the generative AI model in a more efficient manner. The processor does not re-process the entire raw documents for each session, but instead conditions prompt sentences on compact representations, improving processing speed and reducing network communication between the server and the generative AI model.

### 3. Generation of Inquiry Sentences and Explanation Sentences

The server generates prompt sentences for producing inquiry sentences and explanation sentences. In one example, the user is a recruitment operator and configures the system to generate cultural-fit interview questions. The server retrieves the learned representation data and constructs a second prompt sentence such as:

“Using the following organizational values and behavioral norms, generate five open-ended interview questions to evaluate cultural fit. Focus on teamwork, ownership, and learning.”

In another example, the user is a planner for a product feedback campaign, and the server generates a prompt sentence such as:

“Generate questions that elicit customers' honest opinions about this product, focusing on usability and time-saving benefits.”

The server supplies the prompt sentence and learned representation data as input to the generative AI model. The model again executes forward propagation and outputs a sequence of tokens that form multiple inquiry sentences. The server parses the output by detecting sentence boundaries and numbering, then stores each inquiry sentence in association with the organizational identifier, the scenario type, and the prompt sentence used.

Similarly, the server generates explanation sentences. For example, when a job candidate requires a high-level overview of company culture, the server constructs a third prompt sentence such as:

“Explain the company's philosophy and culture to a job candidate. Include concrete examples about teamwork, communication, and decision-making.”

The server concatenates this prompt sentence with the learned representation data and causes the generative AI model to produce a narrative explanation. The explanation is stored and transmitted to the terminal for display.

The generation of inquiry sentences and explanation sentences via prompt sentences allows the server to steer the generative AI model toward domain-specific outputs without retraining the model. The server can vary the number of questions, abstraction level, and targeted behavioral characteristics by adjusting the content of the prompt sentences. This approach reduces computational cost because it avoids repeated fine-tuning while providing context-appropriate questions, which is a technical improvement to model usage efficiency.

### 4. Acquisition and Processing of User Responses

The user reads the inquiry sentences or explanation sentences presented on the terminal and provides responses. The user may speak into the microphone, causing the terminal to acquire audio information. The terminal encodes the audio information and transmits it to the server or, in another embodiment, the terminal locally invokes a speech recognition service to convert the audio information into character information and sends the character information to the server.

The server receives audio information when speech recognition is performed on the server side. The server passes the audio information to a speech recognition component that performs acoustic feature extraction, such as Mel-frequency cepstral coefficient extraction, then feeds the features into a neural network-based recognizer (for example, a recurrent neural network or transformer recognizer) configured with an acoustic model and a language model. The recognizer outputs character information representing a transcription of the spoken response.

The server also receives image information obtained from the terminal's camera. The terminal may provide sampled video frames at a predetermined frame rate. The server forwards these frames to an emotion specifying module that uses a convolutional neural network to detect facial landmarks and classify facial expressions. The network is trained to output probabilities for emotion categories such as joy, interest, confusion, or stress.

The server uses a natural language processing library to process character information representing the response content. The server performs tokenization, part-of-speech tagging, dependency parsing, and sentiment analysis, producing analysis data that includes:
a list of key phrases such as “time saving,” “easy communication,” or “unclear evaluation”,
sentiment scores (for example, numerical values indicating positivity or negativity),
representative topics derived from a topic model.

The server associates the analysis data and the estimated emotional state with the corresponding inquiry sentence, explanation sentence, and session identifier and stores them in the storage device. By maintaining such associations at a per-utterance level, the server establishes a fine-grained mapping between model-generated content and user reaction, which improves the accuracy of subsequent adaptive prompt generation.

### 5. Dynamic Prompt Generation and Closed-Loop Control

The server uses the analysis data and emotional state to dynamically generate additional prompt sentences. In contrast to conventional systems that rely on static scripts, the server computes a new prompt sentence during an ongoing dialogue whenever the emotional state or content features satisfy a predetermined condition. For example, when the analysis data indicates that the user discusses “teamwork” with strongly positive sentiment and the emotion specifying module indicates a high interest score, the server generates a prompt sentence such as:

“The user is highly interested in teamwork. Generate two follow-up questions to explore specific experiences and expectations about teamwork.”

When the emotional state indicates confusion about a concept, the server constructs a different prompt sentence, for example:

“The candidate seems confused about the performance evaluation process. Re-explain the process in simple, step-by-step language with a concrete example.”

The server sends these prompt sentences and the relevant learned representation data to the generative AI model. The model outputs follow-up inquiry sentences or supplementary explanation sentences that are tailored to the current analysis data and emotional state. The server immediately transmits these generated sentences to the terminal as new content in the ongoing interaction.

This closed-loop control, in which analysis data and emotional state are used to compute new prompt sentences to adjust the behavior of the generative AI model in real time, improves technical performance. The server reduces generation of irrelevant or redundant sentences by focusing generation on topics that are identified as relevant to the user state. This reduces network bandwidth between the server and the terminal, as fewer unnecessary messages are exchanged, and improves processing efficiency by reducing wasted compute cycles in both the generative AI model and emotion specifying module.

### 6. Storage Structure and Update of Generation Policy

The server uses structured records in the storage device to maintain relationships between prompt sentences, generated sentences, user responses, and emotional states. For each interaction unit, the server records:
an identifier of the prompt sentence,
content of the prompt sentence,
generated inquiry or explanation sentence,
a response content field containing character information,
an emotional state vector representing scores for each emotion category, and
analysis data including key phrases and sentiment scores.

The server periodically scans these records to discover which prompt sentences and generated sentence types are associated with desired outcomes, such as longer answers, higher information density, or identifiable emotional comfort. The server applies clustering or classification algorithms to the records and updates a generation policy. The generation policy includes parameters such as which phrase templates to include in prompt sentences for specific scenarios and which constraints on number of questions or abstraction level yield better engagement.

By updating the generation policy based on stored associations, the server improves the quality of future prompt sentences without manually redesigning them. This is not a mere automation of human scripting; the server uses statistical relationships learned from large collections of interactions to automatically refine prompt patterns. As a result, the processor reduces the number of iterations required to obtain detailed answers, increasing throughput and reducing total server time per session.

### 7. Training and Internal Operation of Neural Components

In one embodiment, the generative AI model is pre-trained by a third-party provider on general-purpose natural language data. The server does not modify the global model parameters, but instead performs conditional prompting. However, to improve adaptation, the server can perform additional fine-tuning or adapter-based training. The server obtains a set of organizational documents and generates training pairs, where the input includes a partial organizational description and a fixed meta-prompt, and the output includes desired summaries or question patterns. The server defines an error function such as cross-entropy between generated tokens and target tokens and uses gradient descent to adjust a limited subset of parameters (for example, adapter layers). This fine-tuned representation improves convergence speed during inference when processing new prompt sentences related to the specific organization.

The emotion specifying module uses a neural classifier trained on facial expression datasets and speech tone datasets. The server defines labels such as “high interest,” “low interest,” “confusion,” and “stress” and trains the module to output a probability vector. The server minimizes a loss function such as cross-entropy between predicted probabilities and ground-truth labels. The trained classifier is then applied in real time to user images and audio features.

These training operations improve classification accuracy compared to heuristic rules, which in turn improves the relevance of dynamic prompt sentences. Because misclassification of emotions could lead to inappropriate follow-up inquiries, the improved classifier reduces error rates and increases effective use of generative AI model capacity.

### 8. Technical Advantages and Effects

The described system yields several technical advantages beyond automation of human interviewing:

The server reduces redundant text generation by conditioning generative outputs tightly on analysis data and emotional state, thus improving computational efficiency. The server reduces network traffic between the server and terminal by minimizing the transmission of unused or irrelevant content and by outputting shorter, targeted follow-up sentences.

The server improves accuracy of information extraction by constructing a closed-loop architecture: the server repeatedly refines prompt sentences based on real-time feedback from natural language and emotional analysis. This closed-loop architecture allows the computing system to converge quickly on topics that are important to the user, minimizing extraneous dialogue and corresponding computation.

The server improves data management by associating prompt sentences, generated content, and emotional states in a structured storage device with cross-references. This enables machine-assisted optimization of prompt sentences and question patterns without human intervention, which is a technical improvement over traditional static script design.

The server uses non-conventional processing sequences. Instead of executing a simple pipeline “generate questions→collect answers→store logs,” the server performs iterative prompt adjustment governed by analysis data and emotional states, and uses the results to update the generation policy for future sessions. This non-conventional sequence yields reproducible performance gains and reduces latency compared to re-running entire interviews with generic questions.

### 9. Variations and Alternative Embodiments

In another embodiment, the server performs part of the emotion specifying processing on the terminal to reduce server load and network latency. The terminal runs a compact neural classifier that extracts preliminary emotion scores from facial images and transmits only aggregated features to the server. The server then refines the emotional state estimation and uses it in the same way for dynamic prompt generation. This configuration further reduces communication bandwidth and improves responsiveness.

In another embodiment, the server uses different generative AI model architectures, such as encoder-decoder transformers, with attention mechanisms between prompt sentences and organizational policy representations. The server may also introduce structured control tokens into prompt sentences, for example, tokens indicating “low abstraction,” “three questions,” or “focus on positive experiences,” allowing the model to follow more precise instructions.

In yet another embodiment, the server applies data augmentation techniques to organizational documents before providing them to the generative AI model. The server may paraphrase policy sentences, generate synthetic examples of behavioral norms, or segment long documents into overlapping windows. This increases robustness of the learned representation data and reduces sensitivity to idiosyncratic document phrasing.

The user may be a candidate, a customer, or a staff member, and the same basic system structure remains valid. The server always functions as a central controller that generates prompt sentences, interacts with a generative AI model, analyzes responses with natural language processing and emotion specifying processing, and adapts dialogue in real time based on technical signals. The terminal always functions as a sensor and presentation apparatus that provides the necessary audio, image, and text data to the server, and delivers adapted content back to the user.

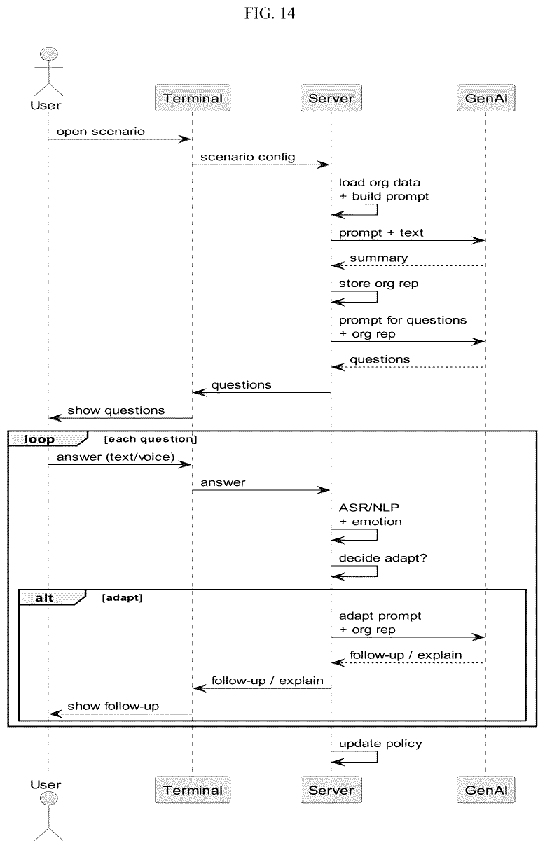

The following describes the processing flow using FIG. 14.

### Step 1:

The server acquires organizational policy data and behavioral-norm data from a storage device.

The input is raw text files and records containing mission statements, policy manuals, and behavioral guidelines.

The server performs data parsing, including removal of markup, sentence boundary detection, and normalization of character encoding, to convert the raw files into clean text segments.

The output is a set of normalized text segments, each tagged with a category such as “policy,” “value,” or “behavioral norm.”

### Step 2:

The server generates a first prompt sentence for conditioning a generative AI model.

The input is the normalized text segments and metadata indicating an organization identifier.

The server concatenates template phrases and key terms (for example, “organizational policy,” “behavioral norms,” “key values”) to construct a prompt sentence such as: “Summarize the following organizational policy and behavioral norms, and list key values and expected behaviors in bullet points.”

The output is a structured prompt sentence string ready to be provided to the generative AI model.

### Step 3:

The server supplies the first prompt sentence and the normalized text segments to the generative AI model.

The input is the prompt sentence and a concatenation of the normalized text segments.

The server tokenizes the combined text, converts tokens into embeddings, and sends the embeddings to the generative AI model through an API call.

The generative AI model performs forward propagation through its transformer layers and returns an output token sequence.

The output is generated text containing summarized values, behavior descriptions, and example narratives.

### Step 4:

The server converts the generated text into learned representation data.

The input is the generated text from the generative AI model.

The server segments the text into bullet points and paragraphs, extracts key phrases by applying a natural language processing library, and encodes them as structured fields (for example, lists of “value descriptors” and “behavior descriptors”).

The output is learned representation data stored in the storage device and linked to the organization identifier.

### Step 5:

The user configures a dialogue scenario through the terminal.

The input is a graphical user interface displaying scenario options such as “cultural fit interview” or “customer feedback.”

The user selects a scenario and optionally enters constraints such as the number of questions and the target topic.

The terminal packages the selected scenario and constraint parameters into a request message.

The output is a scenario configuration message transmitted from the terminal to the server.

### Step 6:

The server generates a second prompt sentence for creating inquiry sentences.

The input is the scenario configuration message and the learned representation data.

The server applies rule-based formatting to insert scenario type, topics, and constraints into a prompt template, producing, for example: “Using the following organizational values and behavioral norms, generate five open-ended interview questions to evaluate cultural fit. Focus on teamwork, ownership, and learning.”

The output is the second prompt sentence tailored to the specified scenario.

### Step 7:

The server calls the generative AI model to generate inquiry sentences.

The input is the second prompt sentence and the learned representation data.

The server concatenates the prompt sentence and representation text, tokenizes them, and sends the tokens to the generative AI model.

The generative AI model computes token probabilities and outputs a sequence of tokens that form multiple inquiry sentences.

The output is a set of inquiry sentences extracted from the output token sequence.

### Step 8:

The server stores and organizes the generated inquiry sentences.

The input is the set of inquiry sentences and associated metadata (scenario identifier, prompt identifier, organization identifier).

The server assigns each inquiry sentence a question identifier, normalizes punctuation, and records it in a database table together with the metadata.

The output is a question list stored in the database and indexed for later retrieval.

### Step 9:

The server transmits the first inquiry sentences to the terminal.

The input is a subset of the question list and a session identifier.

The server assembles a response message containing one or more inquiry sentences and a mapping from question identifiers to text content.

The server sends the message to the terminal using a network protocol.

The output is a message arriving at the terminal containing the inquiry sentences to be presented.

### Step 10:

The terminal displays the inquiry sentences to the user.

The input is the message containing inquiry sentences and the associated identifiers.

The terminal renders each sentence on the display, for example as a text block with an input field or a “record answer” button below it.

The output is a visual presentation enabling the user to read the inquiry sentences and respond.

### Step 11:

The user provides a response via text or voice.

The input is the displayed inquiry sentence and the user's intention to answer.

The user either types a text response into an input field or presses a recording button and speaks the answer into the microphone.

The output is, respectively, typed character information on the terminal, or raw audio information captured by the microphone.

### Step 12:

The terminal preprocesses the user response and sends it to the server.

For a text response, the input is the character information and the associated question identifier.

The terminal packages these into a request payload and sends them to the server.

For a voice response, the input is the audio stream and the question identifier.

The terminal either calls a speech-to-text service to convert the audio into text or forwards the audio directly to the server.

The output is a response message sent to the server containing either text or audio plus the question identifier.

### Step 13:

The server performs speech recognition when necessary.

The input is audio information from the terminal and the associated question identifier.

The server extracts acoustic features, passes the features through a speech recognition model to obtain a token sequence, and converts the tokens into character information representing a transcription.

The output is character information representing the user's response, now linked to the question identifier.

### Step 14:

The server executes natural language processing on the response content.

The input is the character information representing the user's response.

The server tokenizes the text, performs part-of-speech tagging, dependency parsing, and sentiment analysis using an NLP library, and extracts key phrases and topic indicators.

The output is analysis data including a list of key phrases, sentiment scores, and topic labels.

### Step 15:

The server estimates the emotional state of the user.

The input is at least one of image information, audio information, and character information for the same response.

The server applies a facial expression classifier to the image information, a prosodic feature classifier to the audio information, and an affective text classifier to the character information, then combines the classification outputs by weighted averaging or another fusion algorithm.

The output is an emotional state vector containing probabilities for emotion categories such as interest, confusion, and stress.

### Step 16:

The server stores the response content, analysis data, and emotional state in association with the inquiry sentence.

The input is the question identifier, the character information of the response, the analysis data, and the emotional state vector.

The server creates a composite record containing these items and writes it into a database table indexed by the session identifier and timestamp.

The output is a persistent record that links the generated inquiry sentence with the user's response and emotional state.

### Step 17:

The server evaluates conditions for dynamic adaptation of the dialogue.

The input is the analysis data and the emotional state for the current and, optionally, previous responses.

The server applies comparison operations and threshold checks, for example verifying whether the interest probability exceeds a high threshold or whether confusion probability is increasing over time, and it detects topics that are repeatedly mentioned.

The output is a decision result indicating whether to generate follow-up inquiries, supplementary explanations, or to continue with the predefined sequence.

### Step 18:

The server generates a third prompt sentence for follow-up content when adaptation is required.

The input is the decision result, the analysis data, the emotional state, and the learned representation data.

The server composes a new prompt sentence by combining templates with the detected topics and emotional labels, for example: “The user is highly interested in teamwork. Generate two follow-up questions to explore specific experiences and expectations about teamwork.” or “The candidate seems confused about the performance evaluation process. Re-explain the process in simple, step-by-step language with a concrete example.”

The output is the third prompt sentence that encodes adaptation instructions for the generative AI model.

### Step 19:

The server calls the generative AI model to obtain follow-up inquiry sentences or supplementary explanation sentences.

The input is the third prompt sentence and the learned representation data.

The server tokenizes and embeds the combined text and sends it to the generative AI model, which generates an output token sequence representing the follow-up content.

The server decodes the tokens into text, splits it into discrete sentences, and identifies which sentences are inquiries and which are explanations based on sentence structure.

The output is a set of follow-up inquiry sentences and/or supplementary explanation sentences.

### Step 20:

The server transmits the generated follow-up content and, optionally, a response policy to the terminal as real-time feedback.

The input is the newly generated sentences and any associated response policy text derived from the same generative call.

The server constructs a response message including the sentences, their types (question or explanation), and display priority, and sends the message over the network to the terminal while the dialogue session remains active.

The output is a feedback message arriving at the terminal containing content adapted to the current user state.

### Step 21:

The terminal updates the user interface to present the real-time feedback.

The input is the feedback message from the server, including follow-up inquiry sentences or supplementary explanation sentences.

The terminal inserts the new sentences into the display, for example appending them to a conversation view or highlighting them as “follow-up” items, and may play them via a text-to-speech engine.

The output is an updated user interface that reflects the adapted dialogue, enabling the user to immediately react to the feedback or answer the follow-up inquiries.

### Step 22:

The server periodically updates the generation policy based on stored interaction records.

The input is a set of stored records containing prompt sentences, generated sentences, response contents, and emotional states for multiple sessions.

The server computes statistics such as average response length, proportion of positive sentiment, and frequency of high interest for each prompt pattern, then applies clustering or optimization algorithms to identify effective prompt components.

The server modifies internal templates and weighting parameters used when constructing future prompt sentences so that they emphasize effective patterns and suppress ineffective ones.

The output is an updated generation policy that influences how subsequent prompt sentences are generated, thereby improving the quality and efficiency of later interactions.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

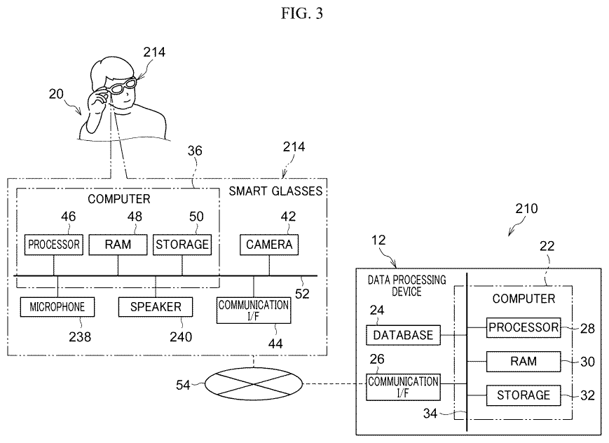

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

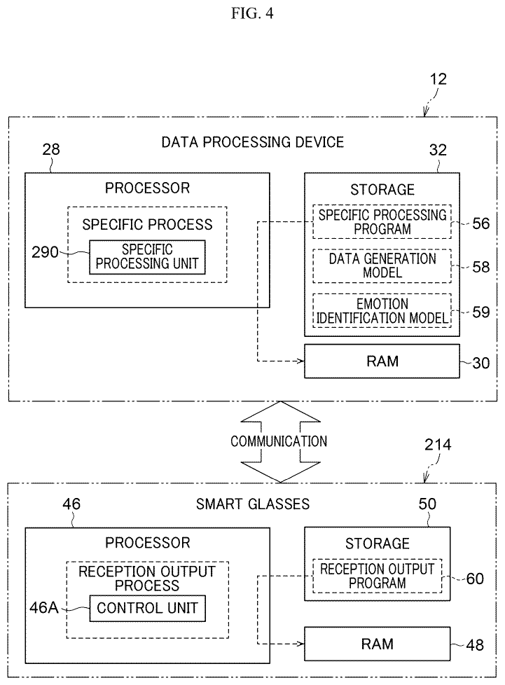

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

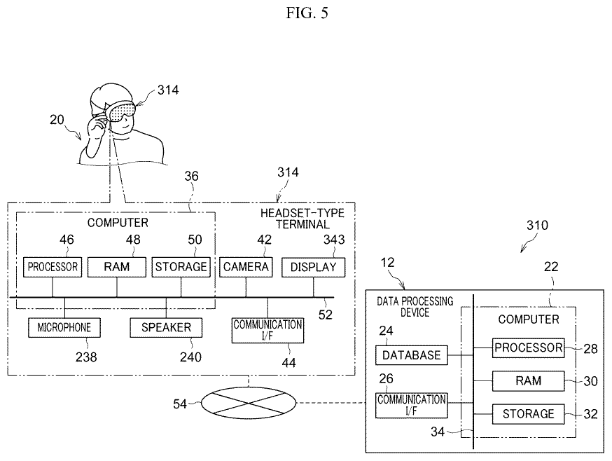

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

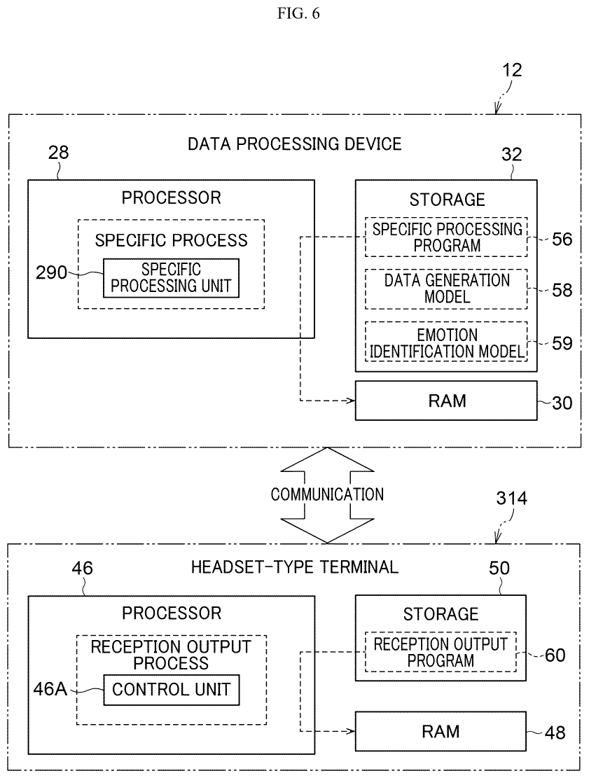

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

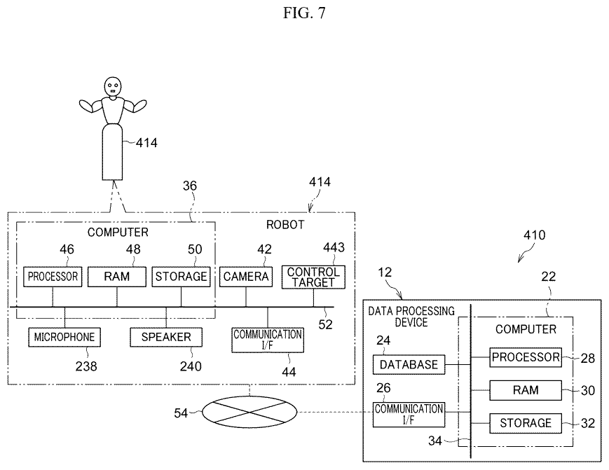

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

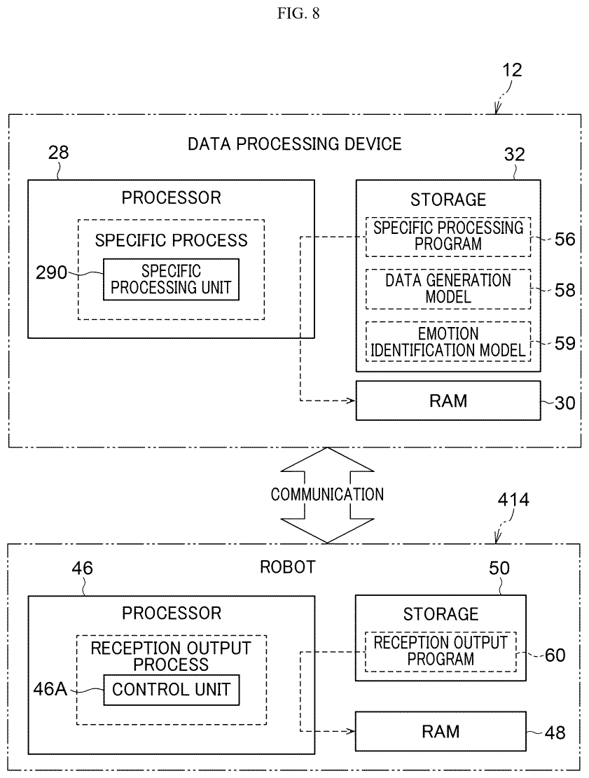

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

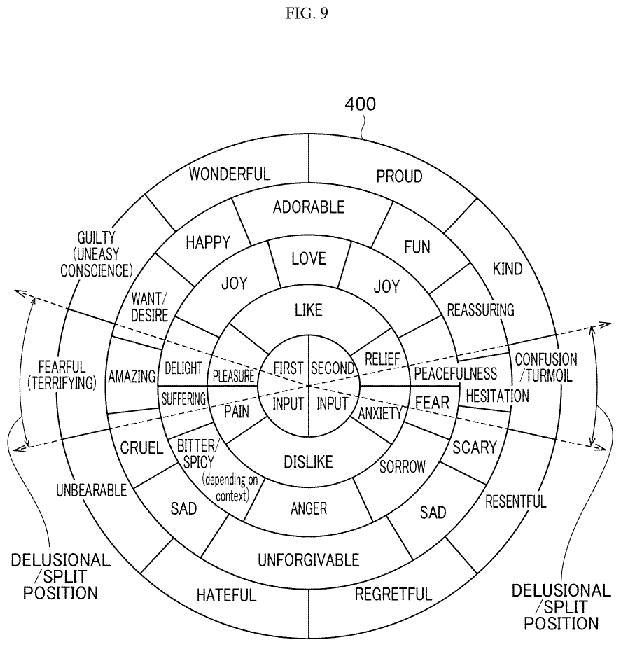

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

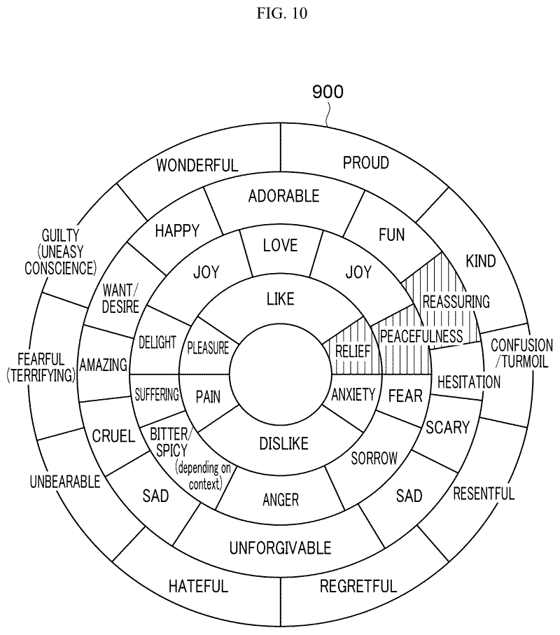

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire descriptive information regarding organizational values and behavioral guidelines from information resources, structure the descriptive information, and store the structured descriptive information in a storage device,
generate a prompt sentence for causing a generative AI model to form a knowledge context regarding the organizational values and behavioral guidelines based on the descriptive information or summary information thereof, and input the prompt sentence and the descriptive information into the generative AI model to cause the generative AI model to form the knowledge context,
generate a prompt sentence for generating an interview question group based on the knowledge context, obtain an interview question list from the generative AI model by using the prompt sentence, and store the interview question list in the storage device,
execute a virtual interview for an applicant via a terminal device based on the interview question list, acquire response data from the applicant, and store the response data as interview session information in the storage device,
generate a prompt sentence for generating evaluation information including a value suitability index or a behavioral characteristic index by analyzing answer content of the applicant based on the interview session information and the knowledge context, obtain the evaluation information from the generative AI model by using the prompt sentence, and store the evaluation information in the storage device, and
generate report information that visualizes an evaluation result regarding organizational suitability of the applicant based on the evaluation information, and provide the report information to a hiring person via a display device or a notification device.

### (Supplementary 2)

The system according to supplementary 1,
wherein the processor is configured to acquire the descriptive information regarding the organizational values and the behavioral guidelines from the information resources by performing processing for acquiring document data from a public information source via a communication network and processing for acquiring business document data from a non-public information source, analyze the document data to extract text segments related to the organizational values and the behavioral guidelines, generate an embedding vector for each of the text segments, store the embedding vectors in a search structure, and, at a time of question generation or answer analysis, search text segments having high relevance based on the embedding vectors and add the searched text segments as input context to the generative AI model.

### (Supplementary 3)

The system according to supplementary 1,
wherein the processor is configured to, upon acquiring the response data of the applicant, generate a prompt sentence for generating a follow-up question based on an original question, the response data, and the knowledge context, obtain the follow-up question from the generative AI model by using the prompt sentence, and present the follow-up question to the applicant via the terminal device to dynamically construct an additional interview for further exploring the values and behavioral characteristics of the applicant.

### Application Example 1

### (Supplementary 1)

A system comprising a processor,
wherein the processor is configured to
analyze character information acquired from an information source related to an organization and extract information regarding a philosophy and a culture of the organization, and generate a prompt sentence for causing a generative AI model to learn the philosophy and the culture of the organization based on the extracted information, and input the prompt sentence and the extracted information into the generative AI model so as to construct the generative AI model configured to perform dialogue generation and evaluation specialized for the organization, and
input interview conditions including a job type and an evaluation viewpoint into the generative AI model, and cause the generative AI model to generate interview questions to be presented to a candidate based on the interview conditions and the philosophy and the culture of the organization, and
transmit the interview questions to a terminal device having a visual display function and cause the terminal device to visually present the interview questions to the candidate, and cause the terminal device to acquire voice information of the candidate and convert the voice information into character information by using a speech recognition technique, and receive the character information from the terminal device, and
input the character information representing an answer of the candidate into the generative AI model, and analyze a meaning and an intention of the answer by natural language processing, and generate evaluation information indicating a degree of consistency of the answer with the philosophy and the culture of the organization, and
output the evaluation information to at least one of the terminal device and an evaluator display device and present an evaluation result regarding suitability of the candidate.

### (Supplementary 2)

The system according to supplementary 1,
wherein the processor is configured to
generate a prompt sentence for causing the generative AI model to generate questions related to contents that are difficult to present in a face-to-face situation and questions for eliciting candid responses, by specifying contents and an expression format of the questions based on the philosophy and the culture of the organization and on the answer of the candidate, and dynamically generate additional interview questions based on the prompt sentence.

### (Supplementary 3)

The system according to supplementary 1,
wherein the processor is configured to
generate evaluation information indicating an emotional state and an attitude tendency of the candidate based on analysis of the answer by the generative AI model, and generate a prompt sentence for changing at least one of a type, a difficulty level, an order, and a presentation timing of subsequent interview questions based on the evaluation information, and dynamically control progress of an interview based on the prompt sentence.

### Example 2

### (Supplementary 1)

A system comprising a processor,
wherein the processor is configured to
acquire text information including guideline information and value information related to an organization, perform preprocessing and feature extraction on the text information, and generate learning data representing a concept structure specific to the organization, and execute a learning process or an adaptation process on a generative AI model implemented by a generative information processing apparatus, using the learning data as input, and construct a generative AI model that reflects the guideline information and the value information of the organization, and
generate a prompt sentence to be input to the generative AI model, the prompt sentence including condition information based on the guideline information and the value information of the organization and including interview target information, and
input the prompt sentence to the generative AI model, cause the generative AI model to generate dialogue output information including question text information for eliciting honest opinions and emotional reactions from a candidate, and transmit the dialogue output information to a terminal device, and
acquire answer text information of the candidate transmitted from the terminal device, analyze the answer text information using natural language processing, extract emotional state information and attitude tendency information from the answer text information, and store the emotional state information and the attitude tendency information as structured data, and
execute an emotion evaluation process and a compatibility estimation process on the structured data, and calculate a compatibility index with the guideline information and the value information of the organization and an emotional state index of the candidate, and generate real-time feedback information to be provided during an interview and evaluation information for an administrator, based on the compatibility index and the emotional state index, and transmit the real-time feedback information to the terminal device.

### (Supplementary 2)

The system according to supplementary 1,
wherein the processor is configured to
generate a prompt sentence including condition information related to question content that is difficult to present in direct human dialogue and question formats that induce honest responses from the candidate, input the prompt sentence to the generative AI model, and cause the generative AI model to generate question text information for extracting internal intentions and latent concerns of the candidate.

### (Supplementary 3)

The system according to supplementary 1,
wherein the processor is configured to
generate a prompt sentence including control conditions related to next question content, question order, and expression format in an interview, based on the emotional state information and the attitude tendency information extracted from the answer text information of the candidate, input the prompt sentence to the generative AI model, and dynamically change interview progress and a question sequence in accordance with the emotional state of the candidate.

### Application Example 2

### (Supplementary 1)

A system comprising a processor,
wherein the processor is configured to
generate a prompt sentence for causing a generative AI model to learn organizational policy and behavioral norms, and perform learning of the organizational policy and the behavioral norms in the generative AI model by using the prompt sentence together with text information regarding the organizational policy and the behavioral norms,
generate a prompt sentence for generating an inquiry sentence or an explanation sentence for eliciting candid opinions and impressions from a dialogue target on the basis of the generative AI model and a result of the learning, cause the generative AI model to generate the inquiry sentence or the explanation sentence based on the prompt sentence, and output the inquiry sentence or the explanation sentence to a terminal apparatus to perform dialogue, acquire audio information, image information, or character information of the dialogue target from the terminal apparatus, analyze a response content of the dialogue target by using speech recognition processing and natural language processing, estimate an emotional state of the dialogue target by using emotion specifying processing, dynamically generate a prompt sentence to be input to the generative AI model on the basis of the emotional state and an analysis result, cause the generative AI model to generate a follow-up inquiry, a supplementary explanation, or a response policy based on the prompt sentence, and output the response policy to the terminal apparatus as real-time feedback, and
store, in a storage device, the response content of the dialogue target, the emotional state, and the inquiry sentence, the explanation sentence, and the response policy generated by the generative AI model in association with one another, and update a generation policy of the prompt sentence or the inquiry sentence on the basis of a result of the storing.

### (Supplementary 2)

The system according to supplementary 1,
wherein the processor is configured to
generate, as the prompt sentence to be input to the generative AI model for generating a plurality of inquiries for eliciting opinions that are difficult for a managed person to express in a direct interpersonal situation or for eliciting candid opinions, a text string specifying constraint conditions including a number of inquiries, an abstraction level of the inquiries, and target behavioral characteristics, and cause the generative AI model to generate the plurality of inquiries based on the text string.

### (Supplementary 3)

The system according to supplementary 1,
wherein the processor is configured to
generate a prompt sentence for dynamically changing explanation items, inquiry contents, and presentation order in an interview or dialogue on the basis of a transition of the emotional state of the dialogue target and the analysis result of the response content, cause the generative AI model to generate a changed explanation sentence or a changed inquiry sentence based on the prompt sentence, and output the changed explanation sentence or the changed inquiry sentence to the terminal apparatus.

What is claimed is:

1. A system comprising:
circuitry configured to:
receive, via a communication interface coupled to a packet-switched network, document data from information resources, analyze the document data to extract descriptive text segments representing entity attribute information and behavioral guidelines, and store the descriptive text segments in a storage device;
generate a first prompt sentence based on the descriptive text segments, transmit the first prompt sentence together with at least a portion of the descriptive text segments to a generative model via the communication interface, and obtain and store a knowledge context data structure from the generative model;
generate a second prompt sentence based on the knowledge context data structure, transmit the second prompt sentence to the generative model via the communication interface to obtain a question list, and store the question list in the storage device;
control a terminal device via the communication interface to present the question list to a respondent, receive response data from the terminal device, and store the response data as session information in the storage device; and
generate a third prompt sentence based on the session information and the knowledge context data structure, transmit the third prompt sentence and at least a portion of the session information to the generative model via the communication interface to obtain evaluation data comprising at least one of an attribute alignment index and a behavioral characteristic index, store the evaluation data in the storage device, and generate report data that visualizes evaluation results based on the evaluation data for transmission to a designated terminal device via the communication interface.

2. The system according to claim 1, wherein analyzing the document data to extract descriptive text segments comprises applying natural language processing to the document data to identify text passages expressing declarative statements about entity attributes, and segmenting the identified text passages into discrete text segments each annotated with a source document identifier and a topic classification.

3. The system according to claim 2, wherein the first prompt sentence is constructed by selecting a subset of text segments from the storage device based on relevance scores computed by matching topic classifications against a predefined attribute category list, and embedding the selected text segments into a knowledge construction template.

4. The system according to claim 1, wherein the knowledge context data structure is stored in the storage device as a vector embedding generated by the generative model from the descriptive text segments, and wherein the second and third prompt sentences are augmented with a context retrieval instruction that directs the generative model to activate the knowledge context data structure during inference.

5. The system according to claim 4, wherein augmenting the second prompt sentence with the context retrieval instruction comprises appending a context identifier associated with the stored knowledge context data structure to the second prompt sentence, and wherein the generative model retrieves the knowledge context data structure from a context cache using the context identifier.

6. The system according to claim 1, wherein the question list is stored in the storage device as a sequence of question records each comprising a question text, a topic classification, and a difficulty level, and wherein presenting the question list to the respondent comprises selecting and sequencing question records from the question list based on an adaptive selection policy stored in the storage device.

7. The system according to claim 6, wherein the adaptive selection policy selects a subsequent question record based on a topic coverage metric computed from the topic classifications of previously presented question records and a target topic distribution stored in the storage device.

8. The system according to claim 1, wherein the circuitry is configured to receive audio data from the terminal device as the response data, convert the audio data into text data using a speech recognition model, and store both the audio data and the text data in the storage device as the session information.

9. The system according to claim 8, wherein the circuitry is configured to analyze facial expression data or voice feature data received from the terminal device using a state estimation model to compute a state indicator, and to incorporate the state indicator as an additional parameter in the third prompt sentence.

10. The system according to claim 9, wherein the state estimation model outputs a state category label and a confidence value, and wherein incorporating the state indicator in the third prompt sentence comprises inserting the state category label and the confidence value into a designated field of a third prompt template.

11. The system according to claim 1, wherein generating the report data comprises constructing a visualization data structure comprising at least a radar chart data set encoding the attribute alignment index across a plurality of attribute dimensions, and transmitting the visualization data structure to the designated terminal device for rendering as a graphical report.

12. The system according to claim 11, wherein the circuitry is configured to generate, based on the evaluation data, a textual summary by transmitting a summary prompt sentence incorporating the evaluation data to the generative model, and to include the textual summary in the report data together with the visualization data structure.

13. The system according to claim 1, wherein the circuitry is configured to generate a follow-up question for a response that satisfies an insufficient-detail criterion, the follow-up question generated by constructing a follow-up prompt sentence that incorporates the question record and the response data for the insufficient response and transmitting the follow-up prompt sentence to the generative model.

14. The system according to claim 13, wherein the insufficient-detail criterion is evaluated by computing a response completeness score based on a ratio of content-bearing tokens in the response data to a minimum token count threshold associated with the corresponding question record.

15. The system according to claim 1, wherein the document data is acquired from a plurality of information resources comprising at least one publicly accessible network resource and at least one non-public data repository, and wherein document data from the non-public data repository is accessed using authentication credentials stored in an access credential store.

16. The system according to claim 15, wherein the circuitry is configured to periodically re-acquire document data from the information resources, identify text segments in the re-acquired document data that differ from stored text segments using a text comparison algorithm, update the descriptive text segments in the storage device based on the identified differences, and regenerate the knowledge context data structure from the updated text segments.

17. The system according to claim 1, wherein the evaluation data further comprises a per-question evaluation record for each question record in the question list, each per-question evaluation record comprising a relevance score representing a degree of alignment between the response data and the descriptive text segments associated with the corresponding topic classification.

18. A system comprising:
circuitry configured to:
receive, via a communication interface coupled to a packet-switched network, document data from information resources, extract descriptive text segments representing entity attribute information from the document data, and store the descriptive text segments in a storage device;
generate a first prompt sentence based on the descriptive text segments, transmit the first prompt sentence to a generative model via the communication interface, and obtain a knowledge context data structure from the generative model;
generate a second prompt sentence based on the knowledge context data structure, obtain a question list from the generative model, present the question list to a respondent via a terminal device, and receive response data from the terminal device; and
generate a third prompt sentence based on the response data and the knowledge context data structure, obtain evaluation data from the generative model comprising at least one of an attribute alignment index and a behavioral characteristic index, and generate report data based on the evaluation data for transmission to a designated terminal device via the communication interface.

19. The system according to claim 18, wherein the circuitry is configured to receive audio data from the terminal device as the response data, convert the audio data into text data using a speech recognition model, and store both the audio data and the text data in the storage device as session information used in generating the third prompt sentence.

20. A method comprising:
receiving, via a communication interface coupled to a packet-switched network, document data from information resources, analyzing the document data to extract descriptive text segments representing entity attribute information and behavioral guidelines, and storing the descriptive text segments in a storage device;
generating a first prompt sentence based on the descriptive text segments, transmitting the first prompt sentence together with at least a portion of the descriptive text segments to a generative model via the communication interface, and obtaining and storing a knowledge context data structure from the generative model;
generating a second prompt sentence based on the knowledge context data structure, transmitting the second prompt sentence to the generative model via the communication interface to obtain a question list, and storing the question list in the storage device;
controlling a terminal device via the communication interface to present the question list to a respondent, receiving response data from the terminal device, and storing the response data as session information in the storage device; and
generating a third prompt sentence based on the session information and the knowledge context data structure, transmitting the third prompt sentence and at least a portion of the session information to the generative model via the communication interface to obtain evaluation data comprising at least one of an attribute alignment index and a behavioral characteristic index, storing the evaluation data in the storage device, and generating report data that visualizes evaluation results based on the evaluation data for transmission to a designated terminal device via the communication interface.
